(19) United States
(12) Patent Application Publication
(10) Pub. No.: US 2026/0289855 A1
(43) Pub. Date: Sep. 24, 2026

(54) SYSTEM

(71) Applicant: SoftBank Group Corp., Tokyo (JP)

(72) Inventor: Zuirin CHEN, Tokyo (JP)

(73) Assignee: SoftBank Group Corp., Tokyo (JP)

(21) Appl. No.: 19/562,897

(22) Filed: Mar. 11, 2026

(30) Foreign Application Priority Data
Mar. 19, 2025 (JP) 2025-044541

(51) Int. Cl. G06T 11/60; G06F 18/2431; G06F 40/166; G06F 40/205; G06F 40/284; G06F 40/40

(52) U.S. Cl. CPC G06T 11/60; G06F 18/2431; G06F 40/166; G06F 40/205; G06F 40/284; G06F 40/40; G06T 2200/24

(57) ABSTRACT

A system includes a processor that is configured to generate visual symbols based on data acquired from a weather database and construct text information corresponding to the data, generate a prompt sentence for instructing a generative AI model to generate text information, the prompt sentence being generated based on options selected by a user, and analyze text information generated by the generative AI model and apply a summarization algorithm to simplify the text information.

### CROSS-REFERENCE TO RELATED APPLICATION

This application is based on and claims priority under 35 USC 119 from Japanese Patent Application No. 2025-044541 filed on Mar. 19, 2025, the disclosure of which is incorporated by reference herein.

### BACKGROUND

### Technical Field

The present disclosure relates to a system.

### Related Art

Japanese Patent Application Laid-Open (JP-A) No. 2022-180282 discloses a persona chatbot control method executed by at least one processor. The method includes steps of: receiving a user utterance, adding the user utterance to a prompt including a description of a chatbot character and an associated instruction sentence, encoding the prompt, and inputting the encoded prompt to a language model to generate a chatbot utterance responding to the user utterance.

Conventional weather information systems mainly provide numerical and symbolic meteorological data, such as temperature, humidity, and weather icons, which are typically generated from structured data stored in weather databases. However, these systems do not effectively transform such data and user-selected contextual options into rich, natural-language descriptions that are both accurate and easy to understand. When generative AI models are used to create text based on weather data, there is a further problem that the generated text can be excessively long, redundant, or inconsistent in style, thereby reducing usability for quick viewing and for publication on information networks. Additionally, existing systems lack an integrated mechanism that, starting from weather database data and user selections, constructs appropriate prompts for a generative AI model, analyzes the output, and applies summarization in a controlled manner suitable for end users and for public dissemination. Therefore, there is a need for a system that can consistently generate, simplify, and distribute natural-language weather-related text information, while reducing the burden on the user and ensuring that the content is concise and formatted for publication.

### SUMMARY

In order to solve the above-described problems, the invention provides a system comprising a processor as defined in the claims. The processor is configured to generate visual symbols based on data acquired from a weather database and to construct text information corresponding to the acquired data. The processor is further configured to generate a prompt sentence for instructing a generative AI model to generate text information, the prompt sentence being generated on the basis of options selected by a user. The processor analyzes text information generated by the generative AI model and applies a summarization algorithm to simplify the text information. In some embodiments, the processor is configured to transmit the text information output from the generative AI model, including the simplified text information, to a terminal of the user, thereby enabling the user to easily view and utilize concise natural-language descriptions derived from weather data and user selections. In certain embodiments, the processor is further configured to convert the text information generated based on the selected options into a publication format and to publish the text information on an information network, so that standardized and easy-to-read weather-related text content can be widely distributed without requiring the user to manually compose or edit detailed textual descriptions.

The term “processor” refers to one or more hardware elements, such as a CPU, GPU, ASIC, or other computing circuitry, and may further include associated memory and control logic, configured to execute instructions for performing the functions described in the claims. The term “weather database” refers to any data storage system, including local or remote databases, data warehouses, or cloud-based data stores, that holds structured or semi-structured meteorological data such as temperature, humidity, precipitation, wind, atmospheric pressure, and related weather parameters.
The term “visual symbols” refers to graphical or pictorial elements, such as icons, images, or other visual indicators, that represent weather conditions or weather-related information derived from data acquired from the weather database.
The term “text information” refers to natural-language content, including sentences, phrases, or paragraphs, generated or processed by the system to describe weather conditions or related contextual information.
The term “options selected by a user” refers to one or more choices, items, or parameters specified by a user through an input interface, such as selections of categories, weather aspects, styles, or levels of detail, which are used to influence the generation of text information.

The term “prompt sentence” refers to a text string or set of text strings formulated to instruct a generative AI model to generate text information, the prompt sentence including content derived from the weather data and the options selected by the user.
The term “generative AI model” refers to a machine-learning model, such as a large language model or other neural network-based generative system, that is configured to generate natural-language text in response to a prompt sentence.
The term “summarization algorithm” refers to a software-implemented procedure or method for condensing text information by reducing redundancy, shortening sentence length, or extracting key information, while preserving essential meaning.
The term “terminal of the user” refers to any user-operated device capable of communicating with the system, such as a smartphone, tablet, personal computer, or other network-connected device, on which the user can view or interact with the generated text information.
The term “publication format” refers to a data structure, layout, or representation suitable for publishing text information on an information network, including but not limited to structured markup, predefined templates, or standardized message formats. The term “information network” refers to a communication network, such as the Internet, an intranet, or another data communication infrastructure, that enables distribution and access to the published text information by one or more users or external systems.

### BRIEF DESCRIPTION OF THE DRAWINGS

Exemplary embodiments of the present disclosure will be described in detail based on the following figures, wherein:

FIG. 1 is a schematic diagram illustrating an example of a configuration of a data processing system according to a first exemplary embodiment;

FIG. 2 is a schematic diagram illustrating an example of relevant functions of a data processing device and a smart device according to the first exemplary embodiment;

FIG. 3 is a schematic diagram illustrating an example of a configuration of a data processing system according to a second exemplary embodiment;

FIG. 4 is a schematic diagram illustrating an example of relevant functions of a data processing device and smart glasses according to the second exemplary embodiment;

FIG. 5 is a schematic diagram illustrating an example of a configuration of a data processing system according to a third exemplary embodiment;

FIG. 6 is a schematic diagram illustrating an example of relevant functions of a data processing device and a headset-type terminal according to the third exemplary embodiment;

FIG. 7 is a schematic diagram illustrating an example of a configuration of a data processing system according to a fourth exemplary embodiment;

FIG. 8 is a schematic diagram illustrating an example of relevant functions of a data processing device and a robot according to the fourth exemplary embodiment;

FIG. 9 illustrates an emotion map mapping plural emotions;

FIG. 10 illustrates an emotion map mapping plural emotions;

FIG. 11 is a sequence diagram showing the flow of data processing system processing in Example 1;

FIG. 12 is a sequence diagram showing the flow of data processing system processing in Application Example 1;

FIG. 13 is a sequence diagram showing the flow of data processing system processing in Example 2; and

FIG. 14 is a sequence diagram showing the flow of data processing system processing in Application Example 2.

### DETAILED DESCRIPTION

Description follows regarding an example of exemplary embodiments of a system according to technology disclosed herein, with reference to the appended drawings.

First, explanation follows regarding terminology employed in the following description.

In the following exemplary embodiments, a reference-numeral-appended processor (hereinafter simply referred to as “processor”) may be implemented by a single computation unit, and may be implemented by a combination of plural computation units. The processor may be implemented by a single type of computation unit, or may be implemented by a combination of plural types of computation units. Examples of computation unit include a central processing unit (CPU), a graphics processing unit (GPU), a general-purpose computing on graphics processing units (GPGPU), an accelerated processing unit (APU), and the like.

In the following exemplary embodiments, random access memory (RAM) appended with a reference numeral is memory temporarily stored with information, and is employed as working memory by a processor.

In the following exemplary embodiments, reference-numeral-appended storage is a single or plural non-volatile storage devices for storing various programs and various parameters and the like. Examples of non-volatile storage devices include flash memory (such as a solid state drive (SSD)), a magnetic disk (for example, a hard disk), magnetic tape, and the like.

In the following exemplary embodiments, a reference-numeral-appended communication interface (I/F) is an interface including a communication processor and an antenna or the like. The communication I/F has the role of communicating between plural computers. An example of a communication standard applied for the communication I/F is a wireless communication standard, such as a Fifth Generation Mobile Communication System (5G), Wi-Fi (registered trademark), Bluetooth (registered trademark), and the like.

In the following exemplary embodiments “A and/or B” has the same definition as “at least one out of A or B”. Namely, “A and/or B” may mean A alone, may mean B alone, or may mean a combination of A and B. Moreover, similar logic to “A and/or B” is applied when “and/or” is employed to link three or more items in the present specification.

### First Exemplary Embodiment

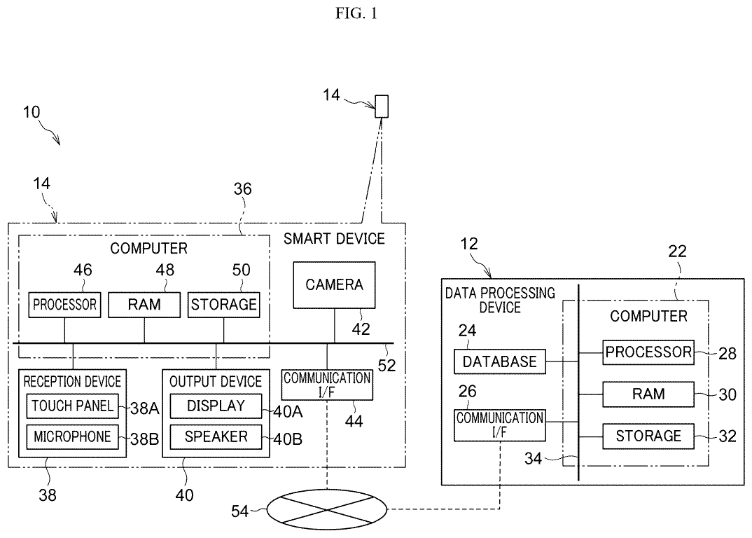

FIG. 1 illustrates an example of a configuration of a data processing system 10 according to a first exemplary embodiment.

As illustrated in FIG. 1, the data processing system 10 includes a data processing device 12 and a smart device 14. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart device 14 includes a computer 36, a reception device 38, an output device 40, a camera 42, and a communication I/F 44. The computer 36 includes a processor 46, RAM 48, and storage 50. The processor 46, the RAM 48, and the storage 50 are connected to a bus 52. The reception device 38, the output device 40, the camera 42, and the communication I/F 44 are also connected to the bus 52.

The reception device 38 includes a touch panel 38A, a microphone 38B, and the like for receiving user input. The touch panel 38A receives user input from contact of a pointer (for example, a pen, a finger, or the like) by detecting contact of the pointer. The microphone 38B receives spoken user input by detecting speech of the user. A control unit 46A in the processor 46 transmits data representing the user input received by the touch panel 38A and the microphone 38B to the data processing device 12. A specific processing unit 290 in the data processing device 12 acquires the data indicating the user input.

The output device 40 includes a display 40A, a speaker 40B, and the like for presenting data to a user 20 by outputting the data in an expression format perceivable by the user 20 (for example, audio and/or text). The display 40A displays visual information such as text, images, or the like under instruction from the processor 46. The speaker 40B outputs audio under instruction from the processor 46. The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like.

The communication I/F 44 is connected to the network 54. The communication I/F 44 and the communication I/F 26 perform the role of exchanging various information between the processor 46 and the processor 28 over the network 54.

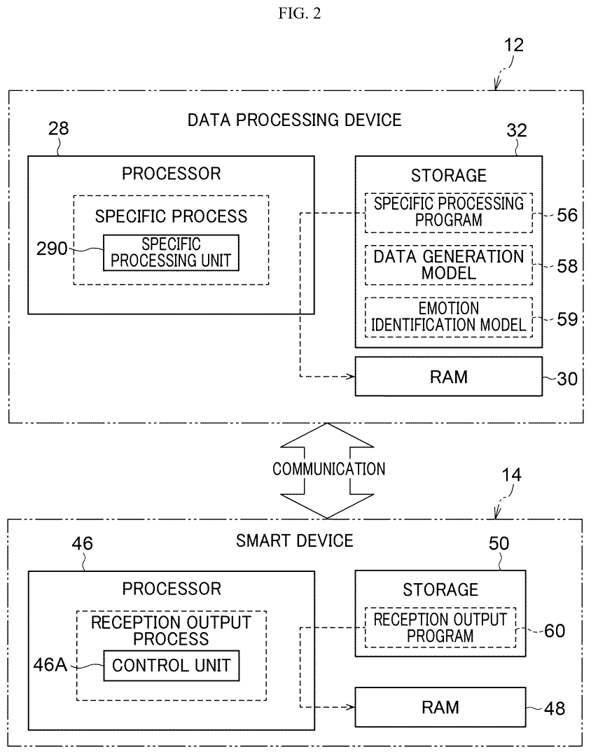

FIG. 2 illustrates an example of relevant functions of the data processing device 12 and the smart device 14.

As illustrated in FIG. 2, specific processing is performed by the processor 28 in the data processing device 12. A specific processing program 56 is stored in the storage 32. The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

A data generation model 58 and an emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart device 14. A reception and output program 60 is stored in the storage 50. The reception and output program 60 is employed by the data processing system 10 in combination with the specific processing program 56. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48. Note that a configuration may be adopted in which a similar data generation model and emotion identification model to the data generation model 58 and the emotion identification model 59 are included in the smart device 14, and these models are used to perform similar processing to the specific processing unit 290. The reception and output program is implemented by the processor 46 operating as the control unit 46A according to the reception and output program 60 executed in the RAM 48.

Note that devices other than the data processing device 12 may include the data generation model 58. For example, a server device (for example, a generation server) may include the data generation model 58. In such cases, the data processing device 12 performs communication with the server device including the data generation model 58 to obtain a processing result (prediction result or the like) obtained using the data generation model 58. The data processing device 12 may be a server device, and may be a terminal device owned by the user (for example, a mobile phone, a robot, a home electrical appliance, or the like). Next, description follows regarding an example of processing by the data processing system 10 according to the first exemplary embodiment.

### Example 1

Description follows regarding a flow of the specific processing in an Example 1. The units of the system described below are implemented by the data processing device 12 and the smart device 14. The data processing device 12 is called a “server” and the smart device 14 is called a “terminal”.

Conventional weather information systems primarily focus on objective meteorological measurements such as temperature, humidity, and precipitation, and present such measurements as raw numeric values or fixed, template-based text. These systems do not adequately capture or communicate how end users subjectively perceive weather conditions, such as how bright the sky feels or how humid the air feels at a given location. As a result, users who wish to share their perceived weather conditions with other users must manually compose free-form text, which is time-consuming, inconsistent in style and quality, and difficult to standardize or reuse across different services and devices.
Furthermore, even when advanced natural language generation techniques are available, conventional systems either (i) rely on static rule-based templates that cannot flexibly adapt to different subjective inputs and usage contexts, or (ii) expose generative AI models directly to front-end applications without a structured mechanism for controlling prompt sentences, constraining output length and style, or integrating subjective selection data with objective weather information. This often leads to generated text that is too long, off-topic, stylistically inappropriate for the target medium (for example, social media versus an information panel), or inconsistent across users and sessions.
From the viewpoint of computer technology, existing architectures lack a processing pipeline in the server that (i) systematically converts structured, subjective selection data from terminal devices into dynamically constructed prompt sentences; (ii) orchestrates interaction with a generative AI model while constraining generation parameters; (iii) programmatically summarizes and simplifies the generated text according to predetermined device-or service-specific conditions; and (iv) associates the simplified text with graphical weather representations in a machine-usable response structure. Without such a pipeline, server-side processing remains ad hoc, difficult to maintain, and inefficient in terms of bandwidth and computation, and it is difficult to ensure predictable, device-appropriate output.
Therefore, there is a need for a computer-implemented technique that improves server-side processing by introducing a structured mechanism to (a) accept and interpret subjective weather-related selections from terminal devices, (b) transform such structured selections into controlled prompt sentences for a generative AI model, (c) post-process and summarize the generated text into a compact, standardized form, and (d) package the text together with graphical weather representations into response data optimized for transmission, display, and publication. Such a technique should improve the functioning of the server system itself, resulting in more efficient data flows, better control over generated content, and more consistent user experiences across different terminals and publication media.

The specific processing by the specific processing unit 290 of the data processing device 12 in Example 1 is realized by the following means.

The present invention provides a server comprising at least one processor and at least one memory storing instructions which, when executed by the at least one processor, cause the server to perform operations comprising: generating, based on meteorological-related information stored in an observation information storage unit, graphical representations indicating weather conditions and constructing text information; receiving, from a communication terminal device, structured information including selection results of a plurality of selectable items representing subjective meteorological sensations, including at least sky brightness and humidity feeling, and analyzing the structured information; dynamically constructing, based on the analysis result, a prompt sentence that serves as an instruction statement for directing a generative AI model to generate text information; transmitting, to a generative information processing model providing apparatus, a generation request including the prompt sentence, and obtaining text information output from a generative information processing model in response to the generation request; applying a summarization processing method to the obtained text information to generate simplified text information in accordance with predetermined conditions relating to sentence length and expression style; and generating response structured information in which the graphical representations, the simplified text information, and the selection results are associated with each other, and outputting the response structured information as response data transmittable to the communication terminal device via a communication control unit. This enables improved computer-implemented processing by allowing the server to systematically translate structured subjective input into controlled prompt sentences for a generative AI model, to constrain and summarize generated text into compact, device-appropriate responses, and to integrate such responses with graphical weather representations in a machine-usable format, thereby enhancing processing efficiency, predictability of generated content, and consistency of user experience across networks and terminal devices.

The term “system” refers to an arrangement of one or more computing devices, communication components, and data storage components that cooperate to execute the functions described in the claims.
The term “processor” refers to one or more hardware processing units, such as a central processing unit or a processing core, capable of executing machine-readable instructions to perform logical and arithmetic operations.
The term “memory” refers to one or more non-transitory computer-readable storage media, such as semiconductor memory, magnetic storage, or optical storage, configured to store data and program instructions for access by the processor.
The term “observation information storage unit” refers to a logical or physical data storage component configured to store meteorological-related information, including at least weather condition data used to generate graphical representations and text information.
The term “meteorological-related information” refers to data representing environmental conditions, including at least weather, temperature, humidity, and other atmospheric parameters, which may be measured, estimated, or obtained from an external data source.
The term “graphical representations” refers to visual elements, such as icons, symbols, or images, that indicate weather conditions or related states in a form suitable for display on a screen or graphical interface.
The term “text information” refers to information expressed in a natural language string or character sequence, representing a description or explanation of weather conditions or related sensations.
The term “communication terminal device” refers to a user-operated electronic device, such as a mobile terminal, portable computing device, or stationary client device, that communicates with the server via a communication network.
The term “subjective meteorological sensations” refers to user-perceived aspects of weather conditions, including at least how bright the sky appears and how humid the air feels, as selected or indicated by a user rather than measured objectively.
The term “structured information” refers to data organized according to a predefined schema or format, such as a key-value structure or a hierarchical data structure, which includes selection results of multiple selectable items.
The term “selection results” refers to values or identifiers corresponding to choices made by a user from among a plurality of selectable items presented by a terminal device.
The term “selectable items” refers to predefined options or categories that can be chosen by a user to express subjective meteorological sensations, including at least options for sky brightness and humidity feeling.
The term “sky brightness” refers to a subjective measure of how bright or dark the sky appears to a user, represented as one of multiple selectable options in the system.
The term “humidity feeling” refers to a subjective measure of how humid or dry the air feels to a user, represented as one of multiple selectable options in the system.
The term “generative AI model” refers to a generative information processing model implemented by a machine learning or neural network algorithm that, upon receiving input including a prompt sentence, outputs text information generated by learned statistical relationships in the model.
The term “generative information processing model providing apparatus” refers to a computing device or service that hosts and executes a generative AI model, receives generation requests including prompt sentences, and returns generated text information.
The term “prompt sentence” refers to an instruction statement, expressed in a natural language or structured textual form, constructed based on structured information and provided as input to a generative AI model to direct generation of text information.
The term “generation request” refers to a request message transmitted to a generative information processing model providing apparatus, the message including at least a prompt sentence and optionally generation parameters.
The term “summarization processing method” refers to an algorithmic procedure executed by the processor to reduce, compress, or rephrase text information while preserving essential content, in order to generate simplified text information.
The term “simplified text information” refers to text information that has been processed by a summarization processing method such that its length, style, or complexity is reduced in accordance with predetermined conditions.
The term “predetermined conditions” refers to one or more rules or parameters defined in advance, including at least conditions relating to sentence length and expression style, that govern how text information is summarized or generated.
The term “expression style” refers to characteristics of text such as tone, formality level, point of view, or stylistic constraints specified for generated or summarized text information.
The term “response structured information” refers to a data structure in which graphical representations, simplified text information, and selection results are associated with one another in a machine-readable format.
The term “response data” refers to data generated by the server based on response structured information and formatted for transmission to a communication terminal device via a communication control unit.
The term “communication control unit” refers to a hardware or software component configured to manage data transmission and reception between the server and communication terminal devices over a communication network.
The term “generation condition” refers to a parameter or constraint applied to the generation of text information by the generative information processing model, including at least a condition relating to language, writing style, sentence length, or publication medium type.
The term “use language” refers to the natural language, such as a particular human language, specified as the target language for generated text information.
The term “writing style” refers to textual characteristics such as formal, informal, neutral, or casual style imposed on the generated text information.
The term “sentence length” refers to the length of generated text information, which may be constrained by the number of characters, words, or sentences.
The term “publication medium type” refers to a classification of a target medium for displaying or distributing text information, including at least a social media platform, an information provision interface, or another publishing environment.
The term “social media use” refers to a usage form in which generated text information is intended to be posted or shared on a communication platform that supports user-generated content and social interaction.
The term “information provision use” refers to a usage form in which generated text information is intended to be displayed as explanatory or descriptive content within an information service or application.
The term “another usage form” refers to any usage mode for generated text information other than social media use or information provision use, including but not limited to messaging, logging, or internal analysis.
The term “description format for information publication” refers to a data or markup format suitable for publishing information through an information communication network, including formats that combine text and graphical elements for external display or distribution.
The term “information communication network” refers to a wired or wireless communication infrastructure, such as the Internet or another packet-switched network, used to transmit data between the server, terminal devices, and external publication information sources.
The term “external publication information source” refers to a server, service, or storage entity external to the server system, which receives converted information and makes the information publicly viewable or accessible to other users.
The term “publicly viewable information” refers to information that is made available through an information communication network such that multiple users, other than the originating user, can access and view the information.

The server implements an embodiment of the invention as a network-accessible computing node equipped with at least one processor, at least one memory, a communication control unit, and a persistent storage device. The server executes an operating system such as a generic server operating system, and runs an application program composed of multiple software modules, including a data acquisition module, a prompt construction module, a generative AI interface module, a summarization module, and a response generation module. The server uses a data storage structure serving as an observation information storage unit, for example a relational database or a key-value store, in which meteorological-related information is recorded as structured records.
The terminal operates as a user-facing device, such as a smartphone, tablet, or other portable information processing apparatus, executing a mobile operating system and a weather application program. The terminal includes a user interface unit, an input unit (for example, a touch panel), a display unit, and a communication unit for communicating with the server via a communication network such as the Internet. The terminal stores and executes application code built using a generic mobile application framework, such as an application framework for a mobile operating system, and uses a networking library to transmit and receive structured information to and from the server.
The user interacts with the system by operating the terminal. The user starts the weather application, observes environmental conditions, and selects subjective meteorological sensations using graphical user interface elements. The user does not directly access the server or the generative AI model; instead, the user's inputs are converted by the terminal into structured information that is transmitted to the server.
The server uses the observation information storage unit to store meteorological-related information that may include, for example, weather condition codes, temperature values, humidity values, cloud coverage, and other atmospheric parameters. The server stores such data in a table-like structure having fields such as a location identifier, a timestamp, and various scalar attributes. The server periodically retrieves or receives updates of meteorological-related information from external data sources and normalizes this data into predefined schemas. The server, based on these stored values, generates graphical representations, such as icons for sunny, cloudy, rainy, or foggy states, by mapping numerical or categorical meteorological attributes to icon identifiers in an icon mapping table.
The server constructs text information that expresses objective weather conditions by applying rule-based templates to values retrieved from the observation information storage unit. For example, the server may construct a sentence such as “The temperature is 25 degrees and the sky is mostly clear,” by formatting values into a template structure. The server stores such text information as part of internal records used later for association with subjective descriptions generated via the generative AI model.
The terminal displays selectable items representing subjective meteorological sensations, including at least “sky brightness” and “humidity feeling.” The terminal presents these items as lists, buttons, or other user interface widgets. The terminal maintains an internal data structure, such as a dictionary or object, that holds current selection results for each selectable item. When the user selects “bright” for sky brightness and “humid” for humidity feeling, the terminal updates the corresponding fields in this internal structure.
The terminal converts the internal selection structure into structured information conforming to a defined schema. The terminal includes, for example, a field representing sky brightness, a field representing humidity feeling, and optionally additional fields such as a location indicator and a usage context indicator. The terminal stores this structured information temporarily in memory and transmits it to the server via the communication unit, using a standardized request format.
The server receives the structured information from the terminal via the communication control unit. The server uses a parsing module to decode the incoming data into a data structure in memory, with fields corresponding to selection results and any additional metadata. The server validates that the structured information conforms to expected value ranges and types, and may perform normalization, such as mapping localized user-facing text options to standardized internal codes.
The server analyzes the structured information to derive semantic attributes that are used in constructing a prompt sentence. The server maps selection results such as “bright” for sky brightness and “humid” for humidity feeling to internal descriptors or tokens. The server then constructs a prompt sentence as a natural-language instruction to a generative AI model. For example, the server constructs one of the following prompt sentences:
“Sky brightness: bright, humidity feeling: humid. Generate one short, natural English sentence that describes how the weather feels to a typical user.”
“Sky brightness: dim, humidity feeling: dry. Generate one concise and neutral English sentence suitable for a weather app description.”
“Sky brightness: overcast, humidity feeling: normal. Write one short, casual English sentence in English that a user might post on social media to describe how the weather feels right now.”
The server dynamically augments the prompt sentence with generation conditions. The server can add phrases specifying output language, tone, sentence length, or intended publication medium. For social media, the server may embed an instruction such as “Make the tone casual and suitable for social media.” For an information panel, the server may embed an instruction such as “Use a neutral and informative tone.”
The server interfaces with a generative AI model that is implemented as a parameterized neural network model stored and executed on a generative information processing model providing apparatus. In one embodiment, the server accesses the generative AI model via an application programming interface exposed by a separate model-serving system. The generative AI model is implemented as a transformer-based neural network with multiple layers of self-attention mechanisms and feedforward sublayers. The generative AI model uses a tokenizer to convert the prompt sentence into token identifiers, applies learned embedding vectors, and propagates token sequences through stacked transformer blocks.
The server provides as input to the generative AI model a sequence of token identifiers corresponding to the prompt sentence and supplies generation parameters such as a sampling temperature, a maximum number of tokens to be generated, and a nucleus sampling threshold. The generative AI model executes inference by repeatedly computing probability distributions over the model's vocabulary and selecting next tokens according to the sampling strategy until an end-of-sequence condition is satisfied. The model architecture includes learned weights for attention matrices and feedforward layers that have been previously trained on large-scale text corpora.
The server, during training of the generative AI model in one embodiment, uses a set of training examples where each prompt sentence is paired with target text describing perceived weather conditions. The server, or a training system cooperating with the server, uses a supervised learning procedure with a loss function such as cross-entropy loss to measure the discrepancy between the predicted token distribution and the target tokens. The training system updates model weights using gradient-based optimization methods, such as stochastic gradient descent with adaptive moment estimation. The training system may employ data augmentation techniques, such as paraphrasing or synonym substitution, to increase robustness of the model to variations in subjective inputs. The server in the deployed system does not retrain the model during normal operation but benefits from the learned parameters obtained via this training.
The server obtains text information from the generative AI model by parsing the model's response, which contains sequences of tokens that are decoded into textual strings. The server applies a summarization processing method to the obtained text information. In one embodiment, the server applies an extractive or abstractive summarization algorithm that enforces constraints on maximum sentence length and style. For example, the server can apply a secondary neural model trained specifically for summarization, or a rule-based algorithm that truncates or rewrites sentences based on linguistic criteria.
The server, by enforcing a maximum number of tokens or characters, reduces the size of the generated text and ensures that the result is suitable for display on constrained devices, such as small-screen terminals. This summarization processing improves data transmission efficiency and reduces rendering load on the terminal. The server uses predetermined conditions, such as target character length ranges and allowed stylistic markers, to control the summarization behavior.
The server generates simplified text information, which is the result of summarization, and associates this simplified text information with the relevant graphical representations and selection results. The server builds response structured information as an internal data structure, such as a nested set of key-value pairs, where fields store identifiers of graphical weather icons, textual strings for simplified text information, and normalized codes for user selections. The server then formats this response structured information into response data suitable for transmission through the communication control unit.
The terminal receives the response data and decodes the response structured information to obtain simplified text information and graphical representations. The terminal updates its user interface by displaying the corresponding weather icon and the simplified text information. The terminal may, for example, display an icon of a bright sun together with a sentence such as “Today the sky is bright and the air feels sticky and humid.” The terminal thereby presents to the user a concise and intuitive description of how the weather feels, without requiring the user to manually compose the sentence.
The server additionally adjusts generation conditions based on device type or network conditions. For example, when the server detects that the terminal is operating over a low-bandwidth connection, the server can configure the generative AI model to produce shorter output and can apply more aggressive summarization. This reduces communication load and accelerates response time. Conversely, when the server detects that the terminal has a larger display and sufficient bandwidth, the server may allow slightly longer descriptive sentences.
The server improves computer technology by organizing the entire processing pipeline into discrete modules with defined data structures and algorithms. The server reduces the amount of textual data that must be transmitted by performing summarization on the server side, thereby lowering bandwidth usage and processing load on terminals. The server also improves consistency and predictability of generated content by constraining the generative AI model through systematically constructed prompt sentences, in contrast to ad hoc free-form use of generative models. Because the server always passes through an intermediate structured representation of subjective selections and uses specified token-length constraints, the system avoids unnecessarily long or off-topic outputs, which reduces downstream filtering and storage requirements.
The server's use of the generative AI model is not a mere automation of human text drafting. The server enforces non-conventional processing rules in constructing prompt sentences that integrate subjective selection codes, objective meteorological attributes, and usage context indicators into a unified instruction structure. The server also applies algorithmic summarization constraints and device-aware formatting before returning responses. These processing steps are not naturally performed by human users and are specifically optimized for digital communication constraints, leading to improvements in computing efficiency and network utilization.
The server, through the prompt construction module and summarization module, reduces computational overhead on the generative AI model providing apparatus. By constructing compact, well-structured prompt sentences and specifying tight output constraints (for example, via maximum token limits and style constraints), the server reduces the number of tokens processed during inference and thus decreases inference time and energy consumption. This yields a technical effect of faster response generation and reduced resource usage on the model-serving infrastructure.
The server, by maintaining a mapping between subjective selection values and trained feature representations in the generative AI model, improves the precision and stability of output text. The server's design ensures that subjective categories such as “bright” or “humid” are consistently encoded into the prompt sentence, leading to more stable model behavior and lower variance in generated text. This reduces the need for post-hoc correction and improves correctness of output with respect to the user's perceived conditions.
The terminal benefits from the server-side processing by receiving compact, pre-structured response data that requires minimal client-side computation to render. This is especially advantageous for low-power devices, as the terminal does not need to run heavy natural language generation or summarization algorithms locally. The division of roles between server and terminal thus improves end-to-end system performance and allows devices with limited hardware capabilities to participate in the system.
The system can be realized in several alternative embodiments. In one embodiment, the generative AI model resides on a separate model-serving server with dedicated hardware acceleration, and the server manages communication with this model-serving server via a secure internal network. In another embodiment, the generative AI model is integrated into the same hardware platform as the server and uses a shared GPU resource for local inference. In yet another embodiment, the server uses multiple generative AI models, selecting among them based on language, domain, or resource constraints, while using a common prompt construction procedure.
The server in some embodiments modifies the internal architecture of the generative AI model to better support weather-related descriptions. For example, the server or an associated training system may extend the model's vocabulary with domain-specific tokens for weather phenomena and subjective sensations. The server may also pre-train or fine-tune the model on corpora consisting of user-generated weather descriptions paired with objective meteorological data and subjective labels, thereby improving alignment between user selections and generated text. The learning procedure minimizes an error function measuring mismatch between generated descriptions and reference descriptions, and updates model weights using gradient-based optimization until a convergence criterion is satisfied.
The system yields technical effects such as improved text generation quality, reduced network load, and improved responsiveness for real-time user interactions. The server integrates meteorological data, subjective selection data, and generative AI outputs in a way that optimizes both computation and communication. The structured construction of prompt sentences and the controlled summarization of generated text result in a system that improves computer functioning beyond a mere implementation of a business or communication idea.

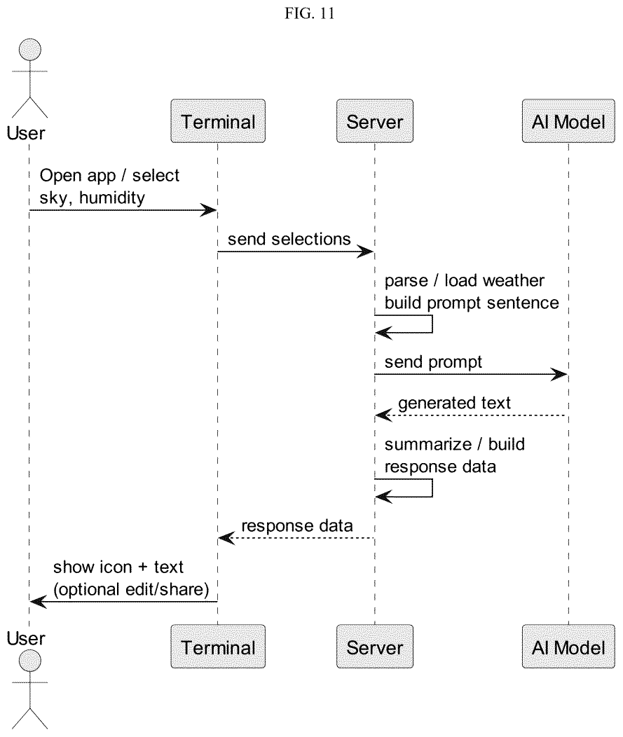

The following describes the processing flow using FIG. 11.

### Step 1

The user activates the weather application on the terminal. The terminal loads user interface resources from local storage and initializes graphical elements such as buttons, selection lists, and icons corresponding to subjective meteorological sensations. The input of this step is the user's action of launching the application, and the output of this step is an initialized user interface ready to receive user selections. The terminal performs internal initialization by allocating memory for data structures that will later store selection results, such as variables for sky brightness and humidity feeling.

### Step 2

The user observes the current weather and selects subjective meteorological sensations on the terminal. The terminal receives tap or click events on selectable items such as “sky brightness” and “humidity feeling” via the operating system's event-handling mechanism. The input of this step is the raw interaction events produced by the user's touch or click actions, and the output of this step is a set of updated internal variables representing selection results (for example, skyBrightness =“bright”, humidityFeeling =“humid”). The terminal processes the events by mapping each UI control identifier to a corresponding internal field and updating that field with the selected value, while changing the visual state of the UI to indicate which options are currently selected.

### Step 3

The terminal constructs structured information representing the user's selection results. The terminal reads the current values of internal selection variables and combines them with optional metadata such as a device identifier, a timestamp, and an intended usage context (for example, “social media” or “information display”). The input of this step is the in-memory state containing selected values and metadata, and the output of this step is a structured data object following a predefined schema with fields such as “sky_brightness”, “humidity_feeling”, and “usage_context”. The terminal performs data processing by organizing these fields into a single logical structure and verifying that all required fields are present before transmission.

### Step 4

The terminal sends the structured information to the server. The terminal's communication unit takes the structured data object as input, serializes it into a standardized transmission format, and attaches it as the body of a network request addressed to the server. The input of this step is the structured selection data within the terminal's memory, and the output of this step is a transmitted request that travels through a communication network and reaches the server. The terminal executes concrete operations such as opening a secure network connection, setting request headers, and writing the serialized data into the network buffer.

### Step 5

The server receives and parses the structured information sent by the terminal. The server's communication control unit accepts incoming network packets and reconstructs the request data. The input of this step is the network-level representation of the user's structured information, and the output of this step is an internal server-side data structure that contains parsed selection results and metadata. The server performs data processing by decoding the request body, validating field types and value ranges, and normalizing external representations (for example, localized labels) into internal codes used for subsequent processing.

### Step 6

The server acquires meteorological-related information from the observation information storage unit. The server uses the normalized selection results and any location or time information included in the structured data to identify relevant records in the storage unit. The input of this step is a query specification derived from structured information (for example, location identifier and time window), and the output of this step is a set of meteorological data records that include objective attributes such as temperature, humidity, and weather condition codes. The server performs data retrieval by executing data-access operations on the storage unit and may perform additional processing such as filtering, averaging, or transforming raw numeric values into categorized states.

### Step 7

The server generates graphical representations and initial text information based on the meteorological-related information. The server takes the retrieved data records as input and applies mapping rules to convert objective attributes into identifiers of weather icons and short descriptive phrases. The input of this step is the set of objective meteorological attributes (for example, a weather condition code and temperature value), and the output of this step is a collection of graphical representation identifiers and one or more sentences expressing objective conditions. The server performs data transformation by referencing an icon mapping table and a template set, inserting numeric values into templates such as “The temperature is X degrees and the sky is mostly clear.”

### Step 8

The server constructs a base prompt sentence from the user's subjective selection results. The server takes as input the internal data structure that includes normalized codes for sky brightness and humidity feeling. The output of this step is a base natural-language string that encodes these selections in textual form, such as “Sky brightness: bright, humidity feeling: humid.” The server performs data processing by mapping internal codes to standardized descriptors and concatenating them using a predefined text pattern that positions each descriptor in a consistent order.

### Step 9

The server augments the base prompt sentence with generation conditions to form a full prompt sentence. The server uses input parameters such as usage context, target language, desired style, and allowed sentence length, which may be derived from the structured information or server configuration. The input of this step is the base prompt sentence and a set of generation condition values, and the output of this step is a full prompt sentence that includes explicit instructions to the generative AI model. For example, the server may produce: “Sky brightness: bright, humidity feeling: humid. Generate one short, natural English sentence that describes how the weather feels to a typical user.” The server performs string operations by appending instruction fragments and condition phrases in a predetermined order so that all necessary constraints are embedded in the prompt sentence.

### Step 10

The server prepares and sends a generation request to the generative AI model. The server takes the full prompt sentence and generation parameters (such as maximum output token count and sampling temperature) as input. The output of this step is a request message delivered to the generative AI model providing apparatus, formatted in accordance with the interface of that apparatus. The server processes data by assembling a request structure containing the prompt sentence and parameters, encoding it in a suitable message format, and transmitting it through a communication channel dedicated to model inference.

### Step 11

The server receives text information generated by the generative AI model. The generative AI model providing apparatus returns a response that contains one or more generated sequences of tokens, which are decoded into natural-language strings. The input of this step is the model's response message, and the output of this step is a textual string, such as “Today the sky is bright and the air feels sticky and humid.” The server performs parsing operations on the response message, extracting the text field and converting any encoded token sequences into a regular character string.

### Step 12

The server applies a summarization processing method to the generated text information. The server takes as input the full-length generated sentence or sentences and the predetermined conditions relating to maximum length and expression style. The output of this step is simplified text information that fits within the specified limits and style constraints. The server performs data processing by either invoking a dedicated summarization algorithm or performing controlled truncation and rephrasing, such as selecting the main clause and removing redundant modifiers, while ensuring that the essential meaning, including sky brightness and humidity feeling, is preserved.

### Step 13

The server generates response structured information that associates simplified text information, graphical representations, and selection results. The server takes as input the simplified text, icon identifiers, and normalized codes for the user's selections. The output of this step is an internal data structure (for example, a composite record) that contains fields linking each icon identifier to corresponding text and subjective codes. The server performs data structuring operations by creating and populating this composite record, ensuring that relationships among elements are explicitly represented for later reconstruction on the terminal.

### Step 14

The server converts the response structured information into response data suitable for transmission. The server takes the composite record as input and encodes it into a transmission format, adding any necessary headers or metadata. The output of this step is a formatted response payload that can be sent over the communication network. The server executes conversion operations by mapping internal field names to external field names, encoding textual content using a specified character encoding, and attaching identifiers needed for the terminal to correctly interpret the graphical representations.

### Step 15

The server sends the response data to the terminal. The server uses the communication control unit to deliver the encoded payload to the network address of the terminal that issued the original request. The input of this step is the formatted response payload in server memory, and the output of this step is a transmitted response that travels through the communication network and becomes available for reception by the terminal. The server performs network-level operations such as opening or reusing a connection, writing the payload into the output buffer, and signaling completion of the transmission.

### Step 16

The terminal receives and decodes the response data from the server. The terminal's communication unit captures incoming network data and passes it to the weather application. The input of this step is the network-level representation of the response payload, and the output of this step is a decoded data structure that contains simplified text information, icon identifiers, and selection codes. The terminal performs decoding operations by parsing the payload according to the expected schema and storing the results in an internal view model or equivalent structure.

### Step 17

The terminal updates its user interface to present the simplified text information and graphical representations. The terminal takes the decoded data structure as input and identifies which graphical components and text labels must be updated on the screen. The output of this step is a rendered display that shows a weather icon and the generated sentence describing the user's perceived weather conditions. The terminal performs rendering operations by setting properties of text display elements to the simplified text, selecting the appropriate icon resource based on the icon identifier, and instructing the display unit to redraw the updated components.

### Step 18

The user reviews the displayed simplified text information and optionally edits it on the terminal. The terminal provides an editable text field pre-filled with the generated sentence and receives new input events if the user modifies the text. The input of this step is the initial simplified text and the user's subsequent keystrokes or touch inputs, and the output of this step is a revised text string stored in the terminal's memory. The terminal processes the events by inserting, deleting, or replacing characters in the text buffer, and by maintaining cursor position and text layout consistent with the user's editing actions.

### Step 19

The user confirms and shares the final text through the terminal. The terminal takes the current text in the editable field as input when the user activates a sharing or posting command. The output of this step is a request to a separate application or service (such as a social platform or messaging application) that carries the final text. The terminal executes concrete operations by invoking a system-level sharing interface, passing the text as a parameter, and handing off control to the selected external application, which then uses the provided text as content for distribution.

### Application Example 1

Description follows regarding a flow of the specific processing in an Application Example 1. The units of the system described below are implemented by the data processing device 12 and the smart device 14. The data processing device 12 is called a “server” and the smart device 14 is called a “terminal”.

Conventional computer-implemented recommendation systems that utilize environmental information such as weather conditions typically rely on static rules or simple mappings between coarse weather categories and pre-defined product lists. Such systems require developers to manually encode if-then rules and keyword lists, which leads to several technical problems: (i) the processing logic for generating recommendations becomes rigid and difficult to scale as the number of weather parameters and user preferences increases; (ii) the system must repeatedly perform bespoke text processing and rule evaluation operations, which increases processing load on the processor and degrades response time; and (iii) the system fails to effectively integrate heterogeneous data sources, such as structured weather data and unstructured user perception inputs, in a manner that can be used efficiently by a text generation engine.
Furthermore, when conventional systems attempt to incorporate a generative AI model, the processor often sends only raw weather data or simplistic prompts to the generative AI model. As a result, the model's output is (i) noisy or overly verbose, making it computationally expensive to analyze on the server side, (ii) poorly aligned with the internal product categorization schema managed by the server, and (iii) difficult to convert into actionable product-type information without complex and inefficient natural language processing pipelines. This architecture leads to increased CPU usage, unnecessary network traffic, and latency, as the server has to perform repeated text parsing and rule-based interpretation of unconstrained generated text.
In addition, conventional systems do not optimize the content of prompt sentences fed to the generative AI model in view of both structured weather information and fine-grained user sensory inputs such as perceived sky brightness and subjective humidity feeling. Without such optimization, the generative AI model cannot reliably generate text that is structurally aligned with the downstream processing requirements of the server, such as extraction of product-type information and mapping to product records in a product information storage apparatus. Consequently, the server cannot achieve efficient end-to-end data processing from acquisition of weather information and user inputs through to construction and transmission of recommendation information.
Accordingly, there is a need for an improved computer-implemented system that (i) systematically integrates current-location weather information and user sensory selection results into a structured generation input text, (ii) converts the generation input text into a prompt sentence tailored for a generative AI model, (iii) constrains and structures the generative AI model's output so that product-type information can be extracted with reduced computational complexity, and (iv) applies summarization processing to produce simplified explanation texts suitable for user interfaces. Such a system should reduce processing overhead on the processor, improve latency in generating recommendation information, and enhance the quality and reliability of product recommendations delivered to user terminals.

The specific processing by the specific processing unit 290 of the data processing device 12 in Application Example 1 is realized by the following means.

The present invention provides a server comprising a processor configured to request acquisition of weather information from a weather information acquisition apparatus on the basis of acquired position information and to acquire current-location weather information from the weather information acquisition apparatus, to generate visual symbols associated with the acquired weather information and to construct text information on the basis of the visual symbols and the weather information, to present, to a user via a user terminal, a plurality of sensory information items including at least a sky brightness item and a humidity feeling item and to receive selection results of the sensory information items from the user, to construct a generation input text on the basis of the weather information and the selection results of the sensory information items, to generate a prompt sentence including the generation input text and to input the prompt sentence to a generative AI model so as to instruct the generative AI model to generate text information, to analyze the text information output from the generative AI model, to extract product-type information from the text information, and to acquire product information corresponding to the product-type information from a product information storage apparatus, to apply summarization processing to the text information output from the generative AI model to generate a simplified explanation text and to construct recommendation information including the explanation text and the product information, and to transmit the recommendation information to the user terminal. This enables the processor to efficiently integrate structured weather data and user sensory selections into a controlled prompt sentence for the generative AI model, to obtain AI-generated text that is optimized for low-cost extraction of product-type information, and to generate concise recommendation information with reduced computational overhead and improved response time for presentation at the user terminal.

The term “processor” refers to a hardware computing element, or a combination of hardware and firmware, that executes machine-readable instructions to perform data acquisition, data processing, generation of control signals, and communication with external apparatuses and terminals.
The term “weather information acquisition apparatus” refers to an information processing apparatus or service, accessible via a communication network, that provides structured weather information such as weather condition, temperature, and humidity in response to an input including position information.
The term “position information” refers to data indicating a geographical position of a user or a user terminal, including at least one of latitude, longitude, and region identifiers, acquired by a positioning function or received from an external source.
The term “current-location weather information” refers to weather information corresponding to a geographical position associated with the user or the user terminal, the weather information including at least one of weather condition, temperature, and humidity at the current location.
The term “visual symbol” refers to a graphical representation or icon that visually expresses at least one aspect of weather information, such as sunshine, cloud, precipitation, temperature range, or humidity level.
The term “text information” refers to character-based data that describes weather information, user sensory conditions, recommendations, or related content in a natural language or a structured text format.
The term “user” refers to a human individual or an entity that operates a user terminal to provide inputs, such as sensory selections, and to receive outputs, such as recommendation information.
The term “user terminal” refers to an electronic device operated by a user, the electronic device including at least a display, an input interface, and a communication interface, and being configured to interact with the server to send and receive information.
The term “sensory information item” refers to a selectable parameter that represents a subjective perception of environmental conditions by the user, including at least one of perceived sky brightness and perceived humidity feeling.
The term “sky brightness item” refers to a sensory information item indicating a user's subjective perception of the brightness or darkness of the sky, categorized into one or more selectable levels.
The term “humidity feeling item” refers to a sensory information item indicating a user's subjective perception of air humidity, categorized into one or more selectable levels such as dry, normal, or sticky.
The term “selection result” refers to information indicating one or more options chosen by the user from among a plurality of sensory information items presented at the user terminal.
The term “generation input text” refers to text information constructed by the processor on the basis of at least the current-location weather information and the selection results of the sensory information items, the text information being used as contextual input for a prompt sentence.
The term “prompt sentence” refers to a text sequence that includes the generation input text and is formatted to be supplied as an input to a generative AI model in order to condition or instruct the generative AI model to generate target text information.
The term “generative AI model” refers to a parameterized computational model that has been trained on text data and that is configured to generate text information in response to input text, including at least a neural network-based language model.
The term “product-type information” refers to information indicating a category or type of product or service, derived from the text information generated by the generative AI model, and usable for retrieval of corresponding product information from a storage apparatus.
The term “product information” refers to data stored in a product information storage apparatus, the data including at least one of product name, category, description, price, and availability status.
The term “product information storage apparatus” refers to an information storage system or database, implemented in hardware and software, configured to store and provide product information in response to queries including product-type information.
The term “summarization processing” refers to a computational operation that reduces the length or complexity of text information while preserving essential content, thereby generating a simplified explanation text from a longer or more detailed text.
The term “simplified explanation text” refers to a condensed form of text information produced by summarization processing, the condensed form being suitable for display at the user terminal as a concise explanation.
The term “recommendation information” refers to combined information constructed by the processor, the combined information including at least the simplified explanation text and one or more pieces of product information, and being configured for presentation to the user.
The term “user interface” refers to a set of display elements and input elements rendered on a user terminal that allows the user to view explanation text and product information and to perform operations such as selection or confirmation.
The term “list format” refers to a display format in which multiple items, such as pieces of product information, are presented as sequential entries, each entry corresponding to a distinct item.
The term “catalog format” refers to a display format in which multiple items, such as pieces of product information, are presented with associated attributes including at least a name and an image, in a manner that allows the user to browse a collection of items.

In an embodiment, a server, a terminal, and a user cooperate to implement the invention described in the claims. The server includes at least one processor, a main memory, a non-transitory storage device, and a network interface. The terminal includes at least one processor, a memory, a display device, an input device such as a touch panel, a wireless communication interface, and a positioning unit such as a GPS receiver that is controlled by an operating system location service. The user operates the terminal to provide sensory selections and to receive recommendation information.
The server executes an operating system such as a general-purpose server operating system and executes server application software implemented, for example, using a server framework. The server further accesses an external weather information acquisition apparatus via a communication network such as the Internet, and accesses a generative AI model hosting apparatus via an application programming interface. The server stores a product information storage apparatus, which may be implemented as a relational database system or a non-relational data store. The terminal executes a client application that communicates with the server using a standard transport protocol such as HTTP over TLS and presents a user interface on the display.
The server treats weather information, sensory information items, selection results, prompt sentences, and generated text information as explicit data structures. For example, the server represents weather information as a record containing fields for weather condition, temperature value, humidity value, wind speed, and region identifier. The server represents sensory information items as a structured configuration, in which each item has an item identifier, a display label, and a set of selectable labels that correspond to internal codes such as numerical levels. The server represents selection results as a key-value mapping between item identifiers and selected codes. The server represents a prompt sentence as a text string that is constructed by inserting normalized weather attributes and normalized sensory selections into predefined language templates.
The server acquires position information from the terminal, and the terminal controls its positioning hardware through an operating system location service to obtain latitude and longitude of the terminal. The terminal transmits the position information to the server via the network interface. The server supplies the position information to the weather information acquisition apparatus. The weather information acquisition apparatus returns weather information as structured data. The server parses this structured data using a parser configured to read structured representations and maps raw numeric or symbolic values into canonical internal categories, such as discrete temperature ranges and humidity ranges. This mapping reduces noise and compresses the feature space that is later presented to the generative AI model.
The server generates visual symbols corresponding to the canonical categories. For example, the server associates a “rain” condition with a rain icon identifier, associates a “cold” temperature range with a thermometer-low icon identifier, and associates a “high humidity” range with a droplet icon identifier. These icon identifiers are transmitted to the terminal, and the terminal renders corresponding visual symbols using a graphical user interface library. By encoding weather states into both text and visual symbol identifiers, the server maintains a compact yet expressive representation that can be reused in different contexts, such as display layout and prompt construction.
The terminal presents, to the user, a user interface that includes sensory information items such as a sky brightness item and a humidity feeling item. The terminal uses its display device and input device to present radio buttons, sliders, or other input controls corresponding to each sensory information item. The user selects, for example, “dark” for the sky brightness item and “sticky” for the humidity feeling item. The terminal converts each sensory selection into a code and transmits the selection result to the server. This conversion ensures that user-perceived states are represented in a finite set of normalized categories suitable for machine processing.
The server constructs a generation input text by concatenating and formatting both the canonicalized weather information and the normalized sensory selections. The server uses a template structure that defines positions in a sentence or paragraph where specific attributes are inserted. The server can, for example, construct a generation input text such as: “The current location has rainy weather with a temperature of 12 degrees Celsius and humidity of 90 percent. The user perceives the sky as dark and the air as sticky.”
The server then generates a prompt sentence that embeds the generation input text together with explicit instructions to the generative AI model regarding the desired output format and semantic constraints. For example, the server can construct a prompt sentence such as:
“The current location has rainy weather with a temperature of 12 degrees Celsius and humidity of 90 percent. The user perceives the sky as dark and the air as sticky. Based on these conditions, describe the current weather in natural language in two sentences, and then list exactly five types of food that would make the user feel warm and comfortable in this weather. For each food type, output a short phrase only, without any additional commentary.”
In another variation, the server can construct a prompt sentence such as:
“The weather information shows light rain, a temperature of 10 degrees Celsius, and high humidity. The user reports that the sky looks very dark and the air feels very humid. First, generate one sentence that empathetically describes the weather. Second, generate a comma-separated list of three hot drink types and three hot meal types suitable for delivery in this weather, using only generic category names.”
The server transmits the prompt sentence to the generative AI model hosting apparatus. In one embodiment, the generative AI model is implemented as a large-scale neural network-based language model, for example, a transformer architecture comprising an embedding layer, a plurality of self-attention layers, and an output projection layer. The generative AI model is trained on a large corpus of text data using a next-token prediction objective or a masked token prediction objective. The generative AI model maintains a vocabulary table that maps subword units to vector embeddings, and the model processes the prompt sentence as a sequence of token identifiers that are mapped into high-dimensional embeddings. The model applies multiple layers of attention and feed-forward transformations to produce an output distribution over tokens at each position.
The generative AI model has internal parameters representing attention weights and feed-forward network weights that are trained by minimizing a loss function such as cross-entropy between predicted tokens and ground truth tokens using stochastic gradient descent or a variant such as Adam. During training, the generative AI model may use data augmentation techniques, such as random masking or random cropping of text segments, to improve generalization. These training aspects ensure that the generative AI model can handle variations in prompt sentences while still producing structured outputs when appropriately conditioned.
The server sends, in addition to the prompt sentence, explicit decoding parameters such as a maximum output token length, a temperature parameter controlling sampling randomness, and optionally a top-k or top-p sampling constraint. By controlling these parameters, the server constrains the form and complexity of generated text and thereby reduces the amount of downstream parsing required. The generative AI model hosting apparatus executes the neural network computations on specialized hardware such as graphics processing units or tensor processing units, and returns generated text information as a text string.
The server receives the generated text information and applies a series of deterministic post-processing operations to transform the unstructured natural language into machine-usable product-type information. For example, the server may split the generated text at pre-defined delimiters, such as commas or line breaks, and apply a keyword mapping table that associates generic noun phrases (e.g., “hot soup,” “ramen,” “herbal tea”) with internal product category identifiers. The server may also apply a lightweight natural language processing algorithm, such as a part-of-speech tagger or a pattern matcher, implemented using a finite-state machine or a rule-based engine, to distinguish between descriptive sentences and list elements.
The server applies summarization processing to the generated text information to produce a simplified explanation text. In one embodiment, the server uses a rule-based summarization algorithm that extracts the first one or two sentences containing core weather descriptors and discards subsequent elaboration. In another embodiment, the server uses an additional trained sequence-to-sequence model configured specifically to compress an input paragraph into one or two sentences, the model being trained using a supervised summarization dataset and a loss function such as cross-entropy between generated summaries and reference summaries. The server may also compute term frequencies and use scoring functions to select sentences with the highest scores for weather-related terms.
By constraining the generative AI model to output text in patterns aligned with these post-processing modules, and by designing the prompt sentence to explicitly separate narrative parts from itemized lists, the server reduces the computational complexity of text analysis. The server avoids heavy-weight natural language understanding pipelines and instead relies on simple, deterministic parsing. This leads to faster processing, lower CPU utilization, and reduced latency in producing recommendations compared to conventional systems that must apply complex semantics analysis to generic, unconstrained AI outputs.
The server then accesses the product information storage apparatus by issuing queries using internal product category identifiers associated with the product-type information. The product information storage apparatus returns product information records including at least product names, categories, descriptions, prices, and available delivery areas. The server combines the product information with the simplified explanation text to construct recommendation information. The recommendation information may be stored internally in a structured object containing fields for an explanation portion and a product list portion. The server transmits the recommendation information to the terminal via the network interface. The terminal parses the recommendation information and renders, on its display device, a text region that shows the simplified explanation text and a list or catalog region that shows product items. The terminal may display product names, images, and prices as individual entries, and may associate each entry with an interaction element that allows the user to request additional details or initiate a purchase operation in another application or within the same client application.
The described configuration produces technical effects that go beyond a mere abstract recommendation concept. The server reduces data volume exchanged with the generative AI model by encoding detailed context into a compact generation input text and prompt sentence, thus reducing the number of tokens to be processed and transmitted. The server improves calculation efficiency by designing prompt sentences that result in outputs amenable to simple rule-based parsing, thereby avoiding expense associated with complex semantic analysis. The server improves data management by maintaining canonical internal categories for both weather and user sensory states, allowing fast indexing and retrieval from the product information storage apparatus.
The terminal also benefits from reduced processing requirements. Because the server has already performed summarization and product-type extraction, the terminal is not required to implement heavy analytic logic and can limit itself to display operations and lightweight input handling. This reduces power consumption on the terminal and improves responsiveness on hardware with limited computing resources.
The generative AI model behaves differently from conventional human rule-making because the server constrains the model with non-conventional prompt structures and decoding parameters that are optimized for downstream extraction, rather than for generic human readability alone. The server instructs the model, through the prompt sentence, to separate narrative and list components, to use generic category names rather than arbitrary product descriptions, and to limit the number of list elements. This non-conventional usage pattern of the generative AI model is specifically designed to minimize parsing complexity, which is a technical improvement in handling machine-generated text.
The training of the generative AI model may be tailored for this application by fine-tuning on a dataset of prompt-output pairs where outputs are required to adhere to the desired structure. For instance, training data may include examples where prompt sentences describe weather conditions and sensory states, and output texts consist of exactly one or two weather-descriptive sentences followed by a list of generic product categories separated by delimiters. During training, the model's parameters are updated using backpropagation and an optimization algorithm to reduce the difference between produced text and target text. This fine-tuning reduces errors such as extraneous commentary or inconsistent item formats, thereby reducing post-processing time and error rates.
In another embodiment, the server maintains multiple templates for prompt sentences corresponding to different device capabilities or network conditions. For a terminal with limited bandwidth, the server may choose a prompt sentence that asks the generative AI model to output a very short explanation and minimal product categories, thereby reducing generated text length and communication overhead. For a terminal with a large display, the server may select a prompt template that allows slightly longer descriptive texts while still preserving a structured list segment.
In yet another embodiment, the server may monitor processing time and error rates associated with parsing generated text and dynamically adjust prompt generation rules. For example, if the server detects that the generative AI model tends to produce extra explanatory sentences before the list of product categories, the server may alter the prompt sentence to provide stricter instructions, such as “Do not output any text except one sentence describing the weather and then a colon-separated list of five food categories.” By closing this feedback loop between model behavior and server-side parsing, the system further improves computational efficiency and robustness.
Because the server orchestrates structured data acquisition from the weather information acquisition apparatus, structured sensory input acquisition from the terminal, and structured text generation from the generative AI model, the system achieves an end-to-end processing pipeline that is technically optimized. This optimization manifests as reduced network load, reduced memory footprint for intermediate representations, reduced CPU cycles for parsing, and improved turnaround time from initial user input to display of recommendations. The combination of canonical categorization, structured prompt sentences, and deterministic parsing provides a technical solution that enables the computer system to function more efficiently than conventional systems that simply attach a generic AI model to existing business logic.
Alternative embodiments may use different types of weather sources, different numbers or types of sensory information items, or different types of generative AI models, such as encoder-decoder architectures, without departing from the technical framework. The server may also employ different summarization algorithms, such as graph-based sentence ranking or attention-based compression, provided that the summarization processing generates a simplified explanation text that reduces the computational load required for display and interpretation at the terminal. The underlying concept of constructing and exploiting a controlled prompt sentence to improve downstream machine processing remains common across these embodiments.

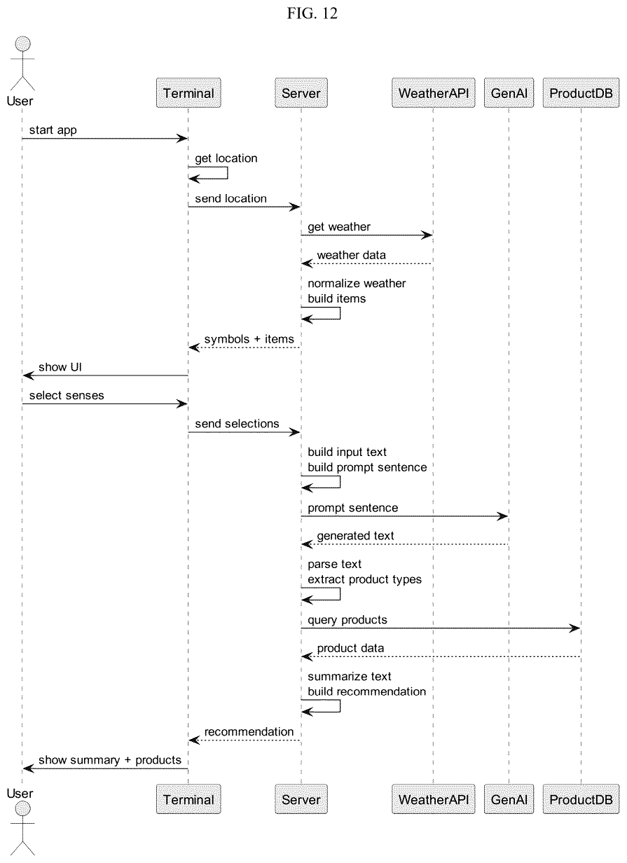

The following describes the processing flow using FIG. 12.

### Step 1

The terminal acquires position information of the user.
The terminal uses a positioning function, such as a GPS module controlled by an operating system location service, to measure latitude and longitude coordinates.
Input: sensor signals from the positioning hardware and configuration parameters from the operating system.
Output: numerical position data including at least latitude and longitude values.
The terminal converts raw sensor readings into normalized position data by invoking system APIs and formats the position data into a structured representation suitable for network transmission.

### Step 2

The terminal transmits the position information to the server.
The terminal establishes a secure communication channel, such as HTTPS, and embeds the position data into a request message.
Input: normalized position data created in Step 1.
Output: a network request that contains the position data and is sent to the server.
The terminal performs data serialization, for example converting internal objects into a text-based format, and appends identification information so that the server can associate the position with a user session.

### Step 3

The server acquires current-location weather information from a weather information acquisition apparatus.
The server receives the position data from the terminal, validates the numerical ranges, and then generates a request message addressed to the external weather information acquisition apparatus.
Input: position data from the terminal.
Output: structured weather information including at least weather condition, temperature, and humidity.
The server performs data processing that includes mapping the received latitude and longitude into query parameters, transmitting these parameters over a network interface, and parsing the response using a structured data parser to produce an internal weather record.

### Step 4

The server normalizes and categorizes the weather information.
The server reads the raw weather condition code, temperature value, and humidity value from the internal weather record and applies threshold-based classification logic.
Input: structured weather information from Step 3.
Output: normalized weather categories such as condition category, temperature band, and humidity band.
The server executes comparison operations and conditional branches to assign each numeric value or symbolic code to a discrete category label, thereby compressing the weather information into canonical forms.

### Step 5

The server generates visual symbols and basic text information based on the normalized weather information.
The server uses the categorized weather information to look up associated visual symbol identifiers and descriptive phrases stored in a mapping table.
Input: normalized weather categories from Step 4.
Output: a set of visual symbol identifiers and a basic weather description text.
The server performs table lookup operations to match category labels with icon identifiers and executes string concatenation operations to construct a short descriptive sentence that explains the current weather in natural language.

### Step 6

The server transmits symbol and item configuration to the terminal.
The server packages visual symbol identifiers and sensory information item definitions into a response message and sends it to the terminal over the network interface.
Input: visual symbol identifiers and item configuration stored in server memory.
Output: a network response containing symbol identifiers and sensory item definitions.
The server performs data structuring by creating a configuration object that lists sensory information items such as a sky brightness item and a humidity feeling item, and attaches display labels and internal codes for each selectable option.

### Step 7

The terminal displays weather-related visual symbols and sensory information items to the user.
The terminal receives the configuration response, decodes the visual symbol identifiers, and maps them to graphical assets stored in the terminal memory.
Input: symbol identifiers and sensory item definitions from Step 6.
Output: a graphical user interface showing visual symbols and selectable sensory information items.
The terminal invokes a user interface library to draw icons that represent the weather and renders input controls, such as buttons or sliders, for each sensory information item with labels that correspond to user-friendly descriptions.

### Step 8

The user selects sensory information items based on subjective perception.
The user observes the actual environment, such as the brightness of the sky and the feeling of humidity, and operates the input controls on the terminal display.
Input: user perception of environmental conditions and the displayed user interface from Step 7.
Output: user selections for each sensory information item, such as a chosen sky brightness level and a chosen humidity feeling level.
The user touches or clicks corresponding controls so that the terminal registers discrete codes representing selected options.

### Step 9

The terminal transmits the selection results to the server.
The terminal converts each selected option into an internal code and groups them into a structured selection record.
Input: user selection codes generated from the user input in Step 8.
Output: a network request message containing the selection results sent to the server. The terminal performs data encoding operations and attaches the selection record to a request directed to a designated endpoint on the server.

### Step 10

The server integrates weather information and selection results to construct a generation input text.
The server retrieves the normalized weather categories from memory and combines them with the sensory selection codes received from the terminal.
Input: normalized weather categories from Step 4 and selection results from Step 9.
Output: a generation input text that describes both objective weather conditions and subjective sensory states.
The server performs a series of string formatting operations, replacing placeholders in a template with actual values such as temperature, humidity, weather condition name, selected sky brightness, and selected humidity feeling, thus generating coherent explanatory text.

### Step 11

The server generates a prompt sentence for a generative AI model.
The server appends instruction segments to the generation input text, specifying constraints such as number of sentences, required output format, and the type of recommended items.
Input: generation input text from Step 10 and template instructions stored in server memory.
Output: a complete prompt sentence intended for conditioning the generative AI model.
The server executes concatenation and token counting routines to ensure that the prompt sentence remains within prescribed length limits and is structurally divided into narrative instructions and list-generation instructions.

### Step 12

The server transmits the prompt sentence to the generative AI model and receives generated text information.
The server prepares a request payload containing the prompt sentence and model control parameters such as maximum token count and sampling temperature, and then sends this payload to a generative AI model hosting apparatus.
Input: prompt sentence from Step 11 and model parameter settings.
Output: generated text information returned from the generative AI model.
The server interacts with the external model via a network API, transmits the prompt sentence, and receives a sequence of tokens that the generative AI model has produced by executing its neural network inference steps.

### Step 13

The server analyzes the generated text information to extract product-type information.
The server applies parsing logic to separate descriptive sentences from itemized portions in the generated text, for example by detecting delimiters such as line breaks or commas.
Input: generated text information from Step 12.
Output: a list of product-type candidates such as generic food or drink categories. The server executes pattern-matching operations and keyword mapping operations that convert detected phrases into internal product-type identifiers, thus transforming human-readable text into machine-interpretable category data.

### Step 14

The server retrieves corresponding product information from a product information storage apparatus.
The server uses the product-type identifiers extracted from the generated text to construct database queries.
Input: product-type identifiers from Step 13.
Output: product information records including at least product names, prices, and other attributes.
The server performs query execution on the product information storage apparatus, filters records by location or availability criteria, and collects relevant product entries into a structured list for recommendation.

### Step 15

The server performs summarization processing to create a simplified explanation text.
The server identifies core weather-descriptive sentences in the generated text and removes redundant or overly detailed segments.
Input: original generated text information from Step 12.
Output: a simplified explanation text consisting of a reduced number of sentences.
The server executes text-scoring or rule-based extraction algorithms that evaluate sentence positions and keyword presence, then selects and recombines only the highest-scoring sentences into a shorter explanation.

### Step 16

The server constructs recommendation information and transmits it to the terminal.
The server combines the simplified explanation text with the list of product information records into a recommendation object.
Input: simplified explanation text from Step 15 and product information from Step 14.
Output: recommendation information containing an explanation portion and a product list portion, transmitted to the terminal.
The server performs data structuring and serialization operations to encode the combined data into a message format, then uses the network interface to send the message to the terminal.

### Step 17

The terminal displays the recommendation information to the user.
The terminal receives the recommendation information, decodes the content, and constructs display elements for the explanation text and the product list.
Input: recommendation information from Step 16.
Output: a rendered screen where the explanation text is shown as a textual element and product items are shown as a list or catalog.
The terminal performs layout calculations, image loading, and text rendering operations so that the user can visually understand the summarized weather explanation and browse through the recommended products.

### Step 18

The user reviews the displayed recommendations and optionally performs follow-up actions.
The user reads the explanation text and scans the product list, then may select a product to view details or initiate an order in a commerce application.
Input: recommendation display from Step 17 and user intent.
Output: user interaction events such as product selection signals.
The user interacts with the terminal through touch or other input modalities, and the resulting events can be captured by the terminal and, if required, transmitted back to the server for logging, analysis, or further recommendation refinement.

It is also possible to incorporate an emotion engine for estimating the user's emotions. That is, the specific processing unit 290 may estimate the user's emotions using an emotion identification model 59, and perform specific processing based on the estimated emotions.

### Example 2

Description follows regarding a flow of the specific processing in an Example 2. The units of the system described below are implemented by the data processing device 12 and the smart device 14. The data processing device 12 is called a “server” and the smart device 14 is called a “terminal”.

Conventional content sharing systems require a user to manually compose free-form text in order to publish status updates, comments, or posts. Even when simplified user interfaces such as check boxes or rating sliders are provided, server-side processing typically treats the collected values as fixed parameters and does not automatically transform them into rich natural-language comments. As a result, the user experience is degraded in that users must either spend time typing long sentences or settle for rigid, template-based messages that lack nuance.

Furthermore, in conventional architectures that incorporate a generative AI model, the construction of a prompt sentence is often static, application-specific, and not aware of the structured nature of the experiential data supplied by the user terminal. The server usually forwards raw user text to the generative AI model without performing systematic analysis, categorization, or constraint-driven prompting. This leads to several technical issues: (i) variability and unpredictability of the generated text length and style, (ii) increased bandwidth due to unnecessarily long AI outputs, (iii) additional client-side logic needed to re-format or truncate AI outputs, and (iv) difficulty in guaranteeing that the generated content fits predefined layout and publication formats of feed user interfaces.

In addition, existing systems do not sufficiently optimize the interaction between the terminal and the server in terms of structured data handling for AI-based generation. User selections on the terminal are often transmitted as loosely defined parameters or unstructured text, which complicates server-side parsing and limits the opportunity to reuse the same structured data across different generative tasks. This lack of well-defined serialization and deserialization of experiential information prevents efficient processing pipelines and makes it difficult to enforce consistent prompt generation rules and output constraints.

Accordingly, there is a need for a system and server-side processing technique that: (1) acquires experiential information from a terminal as structured information, (2) analyzes and converts that experiential information into descriptive text fragments, (3) constructs a prompt sentence that explicitly encodes constraints on length, sentence count, style, and publication format, and (4) interacts with a generative AI model so that the server can reliably obtain short, feed-ready comments without additional post-processing. Such a system should improve the overall computer-implemented pipeline by reducing client-side processing, normalizing server-side prompt construction, optimizing network usage, and ensuring that generated content is automatically adapted to a feed display format.

The specific processing by the specific processing unit 290 of the data processing device 12 in Example 2 is realized by the following means.

The present invention provides a server comprising a processor configured to cause a terminal to display an input interface that receives a user operation for selecting experiential information, to acquire structured information including experiential information selected by the user from the terminal, to analyze the experiential information included in the structured information, to generate descriptive text representing the experiential information, to generate a prompt sentence including the descriptive text and generation conditions for instructing a generative AI model to generate text information in accordance with the generation conditions, to transmit a request including the prompt sentence to the generative AI model and acquire automatically generated text information from the generative AI model based on the prompt sentence, to store the automatically generated text information as content for a user feed, to convert the content for the user feed into feed data displayable on the terminal, and to transmit the feed data to the terminal and cause the terminal to display the content for the user feed. This enables a computer-implemented pipeline in which experiential information is consistently serialized, semantically transformed into category-specific text fragments, embedded into a constraint-aware prompt sentence, and supplied to a generative AI model so that short, layout-compatible feed comments are generated on the server side with reduced client processing, predictable output formatting, and efficient use of network and computing resources.

The term “system” refers to a combination of one or more computing devices and software components that cooperate to execute the processing described in the claims.
The term “processor” refers to a hardware processing unit, such as a central processing unit or other execution unit, capable of executing instructions to perform the described operations.
The term “terminal” refers to a user-operated electronic apparatus, such as a mobile device, a tablet device, a portable information device, or a general-purpose computing device, that executes an application and presents a user interface.
The term “input interface” refers to a graphical or interactive user interface presented on the terminal that receives operations from a user, including selection, touch, click, or similar actions.
The term “user operation” refers to an input action performed by a user via the input interface, including selecting items, pressing buttons, or otherwise manipulating UI components.
The term “experiential information” refers to subjective or perception-based information representing how a user feels or perceives an environment or situation, such as a feeling of brightness, humidity, temperature, or comfort.
The term “structured information” refers to information represented in a predefined, machine-readable data structure in which fields, keys, or attributes are explicitly defined.
The term “lightweight data format” refers to a compact, text-based data representation format suitable for network transmission and structured data exchange, such as a key-value based or hierarchical format.
The term “hierarchical structure” refers to a data organization in which information is arranged in nested elements or levels, such as parent-child relationships among fields.
The term “serialize” refers to a process of converting in-memory data structures into a sequential data representation suitable for storage or transmission.
The term “deserialize” refers to a process of converting a serialized representation of data into in-memory data structures suitable for programmatic access.
The term “analyze” refers to processing structured information to identify, interpret, or classify its constituent elements, including parsing and mapping values to categories.
The term “descriptive text” refers to natural-language text that explains or describes experiential information in a human-readable form.
The term “category-specific text fragments” refers to partial natural-language expressions individually associated with respective categories of experiential information, such as a phrase specifically describing sky brightness or humidity feeling.
The term “prompt sentence” refers to a natural-language sentence or sequence of sentences provided as input to a generative AI model to instruct the model to generate text information.
The term “prompt template” refers to a predefined text pattern including placeholders or positions for inserting category-specific text fragments and output constraint conditions used to construct a prompt sentence.
The term “generation conditions” refers to parameters or constraints that define how the generative AI model should generate text information, including but not limited to style, length, and number of sentences.
The term “output constraint conditions” refers to explicit limitations imposed on the text generated by the generative AI model, such as constraints on length, number of sentences, style, and publication format.
The term “generative AI model” refers to a machine learning model configured to generate natural-language text in response to an input prompt sentence.
The term “request” refers to a message transmitted from the processor to the generative AI model including at least the prompt sentence and optional parameters for text generation.
The term “automatically generated text information” refers to text data produced by the generative AI model without manual editing by the user during the generation process.
The term “user feed” refers to a sequence or collection of content items associated with a user that are presented in a stream-like or timeline-like format.
The term “content for a user feed” refers to information units, including automatically generated text information and associated metadata, that are stored for presentation within a user feed.
The term “feed data” refers to data formatted or arranged for display of content for a user feed on the terminal, including layout-related or presentation-related information.
The term “publication format” refers to a format specification for presenting generated text in a display environment, including constraints related to layout, size, and structural composition suitable for public display.
The term “short comment” refers to a concise text output, typically a single sentence or few sentences, that fits within the output constraint conditions defined for a user feed.

In one embodiment, a server cooperates with a terminal operated by a user to generate natural-language comments based on experiential information selected by the user. The user operates the terminal to launch an application that executes on a mobile operating system, such as a smartphone or tablet operating system. The terminal presents a graphical user interface including interactive components such as pull-down menus, radio buttons, sliders, and buttons. The user selects experiential information items, for example, “brightness of the sky,” “feeling of humidity,” “temperature sensation,” or “comfort level,” by touching the screen and choosing one value from each item.
The terminal executes application software implemented, for example, using a native application framework such as an object-oriented language runtime and a user interface toolkit. The terminal stores the selected values in memory as structured objects including fields representing categories of experiential information. The terminal converts these objects into a structured information representation in a lightweight, hierarchical data format, such as a nested key-value format. The terminal then transmits the structured information to the server using a communication protocol such as HTTPS over a packet-switched network.
The server receives the structured information using a network interface controller and a server-side application framework, such as an HTTP server coupled with a web application runtime. The server parses the structured information, validates data types and allowed values, and maps the experiential information to internal data structures. The server then generates descriptive text fragments associated with each category of experiential information. For example, when the structured information indicates that “brightness of the sky” is “dark,” the server maps this to a text fragment such as “the sky is dark,” and when the structured information indicates that “feeling of humidity” is “dry,” the server maps this to a text fragment such as “the air feels dry.”
The server constructs a prompt sentence for a generative AI model by combining the descriptive text fragments with explicit generation conditions. The server uses a prompt template stored as a parameterized text pattern. The server inserts the category-specific text fragments into the template, and also injects output constraint conditions specifying the desired length, number of sentences, style, and publication format of the generated text. For example, the server generates a prompt sentence such as:
“The user reports that the sky is dark and the air feels dry. Based on this experiential information, generate one short, natural English comment for a social media feed. Limit the comment to one sentence and fewer than 25 words. Do not mention that this is generated by an AI model; just output the comment text.”
In another example, when the experiential information indicates a bright and humid day, the server generates a prompt sentence such as:
“The user reports that the sky is bright and the air feels humid. Generate one short, friendly comment for a social media feed that describes how the weather feels. Limit the comment to one sentence.”
The server provides the prompt sentence to a generative AI model implemented as a neural network. The generative AI model is, in one embodiment, a large-scale transformer-based neural network comprising multiple layers of self-attention and feed-forward sub-networks. The generative AI model is trained in advance on a large corpus of natural-language data and fine-tuned on instruction-following tasks. The server transmits the prompt sentence, together with generation parameters such as maximum output token length, temperature, and top-k or top-p sampling parameters, as an input sequence of token identifiers to an inference engine that executes on hardware accelerators such as graphics processing units or tensor processing units.
The generative AI model processes the input token sequence using a sequence of matrix multiplications, nonlinear activation functions, and attention computations across multiple layers. The model computes contextual embeddings for each token and then predicts successive output tokens according to a probability distribution parameterized by trainable weight matrices. The model generates output token sequences that form automatically generated text information, such as:
“Today the sky feels dark and the air is dry.”
The server receives the generated token sequence from the generative AI model and decodes the tokens into a character string. The server normalizes the resulting text by trimming whitespace, ensuring proper capitalization, and verifying that the generated text satisfies the output constraint conditions embedded in the prompt sentence. If the generated text violates one or more constraints, such as exceeding the permitted number of words, the server can apply post-generation filtering or re-generation rules, including truncation or regeneration with more restrictive parameters. This increases the predictability and layout compatibility of the resulting content.
The server stores the automatically generated text information as content for a user feed in a storage system, such as a relational database management system or a document-oriented database. The server associates each content item with metadata, including a user identifier, a timestamp, the original structured experiential information, and a reference to the prompt sentence used. The server converts the stored content into feed data formatted for display on the terminal. The server may incorporate pagination information, ordering keys, and layout metadata suitable for efficient retrieval and rendering on resource-constrained devices.
The terminal subsequently requests feed data from the server. The server retrieves the appropriate content items from the storage system and packages them into a response message in a structured format. The terminal receives the feed data and updates its local representation of the user feed, for example, in a list structure maintained in memory or in a local database. The terminal renders the feed using the user interface toolkit to display the automatically generated comments as individual entries, along with timestamps and optional interactive controls.
In one embodiment, the server further optimizes data management and communication efficiency by enforcing a fixed schema for the structured information exchanged between the terminal and the server. The server requires that experiential information be encoded using pre-defined keys and enumerated values. This allows the server to perform schema-based validation and to generate prompts using deterministic mappings, which reduces the need for complex natural-language parsing on the server side. By reducing variability in the input space, the server can generate more consistent prompts and thus obtain more predictable outputs from the generative AI model, improving the stability of the overall system.
The server, in one embodiment, uses a modular architecture including distinct modules for input parsing, mapping experiential values to text fragments, prompt construction, generative AI model interfacing, output validation, and feed formatting. Each module processes well-defined data structures and passes results to the subsequent module. For example, the mapping module uses a table of rules that associates combinations of experiential values with canonical text fragments. This rule table can be updated without changing the overall program logic, enabling adaptation to new categories of experiential information while preserving the technical effects of the prompt generation pipeline. The generative AI model, in one embodiment, is trained using a supervised or reinforcement-learning-based fine-tuning method. During training, the model receives prompt sentences similar to those generated by the server and target comments that match desired length and style constraints. The training process minimizes a loss function such as cross-entropy between the model's predicted token distributions and the target tokens. The training uses gradient-based optimization algorithms, such as stochastic gradient descent or adaptive methods, to update the model's weight parameters. Data augmentation techniques, such as paraphrasing, noise injection, and constraint-variation, can be used to expose the model to a diverse set of generation conditions. This training configuration enables the model to produce outputs that adhere more closely to the constraints encoded in the server-generated prompt sentence, thereby reducing the need for post-processing and improving computational efficiency at inference time.
The server applies non-trivial prompt construction logic that differs from simple human-written instructions. The server automatically composes the prompt sentence using structured experiential data, rather than relying on free-form user input. The server specifically encodes machine-readable constraints into natural-language form in the prompt sentence in a consistent pattern, such that the generative AI model learns to respect these constraints. This non-conventional use of structured data to systematically generate constraint-aware natural-language prompts is a technical mechanism that improves the interaction between the server and the generative AI model, leading to shorter, layout-compatible outputs with lower token counts and thus reduced latency and network bandwidth usage.
In another embodiment, the server adaptively adjusts the prompt sentence based on system performance metrics. For example, the server monitors the average number of tokens generated by the generative AI model and, if the average length exceeds a threshold, the server modifies the generation conditions in subsequent prompt sentences to tighten the constraint on maximum length. The server can also incorporate system load or device characteristics into the generation conditions, causing the generative AI model to produce shorter comments when network conditions are poor or when the terminal is a low-performance device. Through such adaptive control, the server improves resource utilization and user-perceived responsiveness of the overall system.
In a further embodiment, the server employs an internal scoring algorithm to evaluate candidate outputs from the generative AI model. The server can request multiple candidate comments by specifying a parameter for multiple generations in the generative AI model. The server then evaluates each candidate using a rule-based or machine-learned scoring function that measures compliance with constraints, semantic coverage of experiential information, and appropriateness for the feed context. The server selects the highest-scoring candidate as the final automatically generated text information. This approach, which relies on structured evaluation criteria and automated candidate selection, provides higher reliability than manual review and yields consistent quality in generated comments.
The system described above provides technical effects beyond mere automation of human writing tasks. By enforcing structured experiential data representation, deterministic mapping to descriptive text fragments, and standardized, constraint-aware prompt construction, the server reduces the variability of inputs to the generative AI model, thereby lowering the entropy of the model's output distribution and improving the predictability and compactness of generated content. This leads to reduced processing time in the generative AI model, fewer output tokens, and reduced communication overhead between the server and the terminal. Additionally, because the generated comments are directly formatted for feed display, the terminal requires minimal additional processing, which is advantageous for devices with restricted computational resources and battery capacity.
The terminal benefits from this architecture by handling primarily structured data exchange and display operations instead of expensive natural-language generation or complex formatting operations. The server centralizes the computationally intensive and structurally complex tasks, such as prompt generation and neural network inference, on hardware optimized for such workloads. This division of labor improves overall system performance and scalability, allowing multiple terminals to share a common server-side generative AI infrastructure.
In yet another embodiment, the server includes a configuration mechanism that allows system administrators to define new experiential categories and associated mapping rules. The server can load these mappings at runtime and incorporate them into the prompt generation logic. Because the server separates the mapping rules from the core prompt construction and generative AI model interfacing logic, the system can evolve to support new experiential domains without altering the fundamental data flow or the technical improvements achieved by structured prompting and constraint management.
Through these embodiments, the server, the terminal, and the generative AI model cooperate to form a computer-implemented system that technically improves data handling, prompt formation, model interaction, and content delivery. The system introduces non-conventional and non-generic implementations of structured data processing and constraint-aware prompting that enhance the functioning of the underlying computer network and generative AI infrastructure, providing faster, more predictable, and more resource-efficient generation of user feed content.

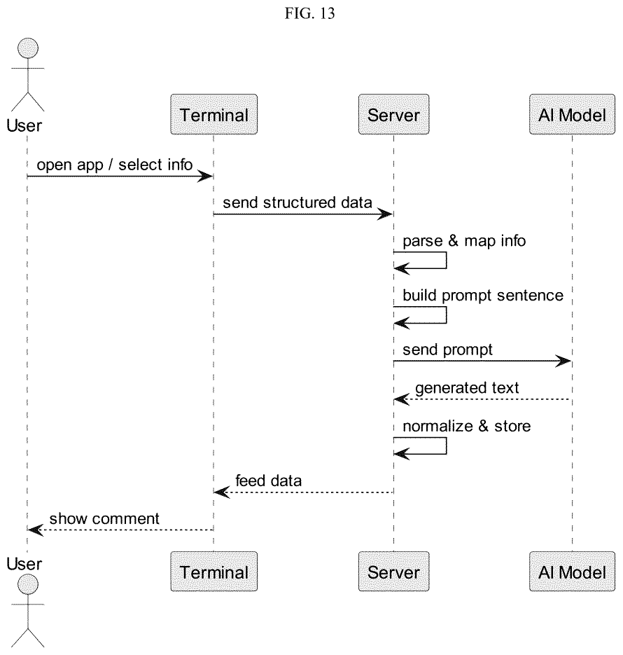

The following describes the processing flow using FIG. 13.

### Step 1

The user operates the terminal to launch an application and open an experiential-information input screen. The input of this step is the application program stored in the terminal and the user's intention to report experiential information. The terminal displays UI components such as pull-down menus and radio buttons for items like “brightness of the sky” and “feeling of humidity.” The user touches the screen to select one value for each item. The output of this step is a set of selected experiential values held temporarily in the terminal's UI state, for example, “sky brightness =dark” and “humidity feeling =dry.”

### Step 2

The terminal executes the application logic to convert the UI selections into structured information. The input of this step is the set of selected experiential values from Step 1. The terminal creates an in-memory data object with fields corresponding to each experiential category and assigns the selected values to those fields. The terminal then serializes this object into a lightweight hierarchical format, such as a nested key-value representation similar to JSON, adding metadata such as a user identifier and a timestamp. The output of this step is a serialized structured-information payload ready for network transmission.

### Step 3

The terminal transmits the structured-information payload to the server over a communication network. The input of this step is the serialized payload from Step 2 and connection parameters for a server endpoint. The terminal uses an HTTP client module to encapsulate the payload in a request message, sets headers including content type, and sends the message via HTTPS. The output of this step is a network-level request delivered to the server, containing the user's experiential information in structured form.

### Step 4

The server receives and parses the structured-information payload. The input of this step is the HTTP request generated in Step 3. The server uses a network interface and an HTTP server module to extract the request body, then applies a parsing routine to deserialize the hierarchical data format into server-side data structures. The server validates that required fields such as user identifier, sky brightness, and humidity feeling are present and that their values are within predefined allowed sets. The output of this step is a validated internal representation of experiential information and associated metadata stored in the server's working memory.

### Step 5

The server maps the experiential values to category-specific descriptive text fragments. The input of this step is the internal representation from Step 4. The server consults a mapping table or rule set that associates each allowed experiential value with a canonical phrase. For example, the server maps “sky brightness =dark” to the phrase “the sky is dark” and “humidity feeling =dry” to the phrase “the air feels dry.” The server concatenates or assembles these phrases into a consistent format. The output of this step is a set of descriptive text fragments expressing the experiential information in natural-language form.

### Step 6

The server constructs a prompt sentence for a generative AI model by combining the descriptive text fragments with explicit generation conditions. The input of this step is the set of descriptive text fragments from Step 5 and configuration parameters specifying constraints such as length, style, and number of sentences. The server applies a prompt template that includes fixed instruction phrases and placeholders for inserting the text fragments and constraints. The server fills the placeholders with the phrases and constraints to form a complete prompt sentence, for example: “The user reports that the sky is dark and the air feels dry. Based on this experiential information, generate one short, natural English comment for a social media feed. Limit the comment to one sentence and fewer than 25 words. Do not mention that this is generated by an AI model; just output the comment text.” The output of this step is a finalized prompt sentence string ready for input to the generative AI model.

### Step 7

The server encodes and submits the prompt sentence to the generative AI model. The input of this step is the prompt sentence from Step 6 and model-inference parameters such as maximum token count and sampling temperature. The server tokenizes the prompt sentence into token identifiers using a tokenizer associated with the generative AI model and constructs a model-input structure including the token sequence and parameter values. The server sends this structure to an inference engine running the generative AI model, typically via an internal API or an external model-serving endpoint. The output of this step is a model-inference request accepted by the generative AI infrastructure.

### Step 8

The server, via the generative AI model, generates a candidate text comment. The input of this step is the tokenized prompt and inference parameters received in Step 7. The generative AI model processes the tokens through a transformer-based neural network, performing matrix multiplications, attention operations, and non-linear activations across multiple layers to compute output token probabilities. The model iteratively selects output tokens according to these probabilities and the specified sampling strategy until a termination condition is reached. The output of this step is an output token sequence representing an automatically generated comment, such as tokens corresponding to “Today the sky feels dark and the air is dry.”

### Step 9

The server decodes, normalizes, and validates the generated comment. The input of this step is the output token sequence from Step 8. The server converts the token sequence back into text, yielding a character string. The server trims leading and trailing whitespace, ensures the string is in the correct character encoding, and performs checks against the constraints embedded in the prompt sentence, such as word count and number of sentences. If the generated text exceeds the allowed length, the server may apply truncation or trigger a re-generation with adjusted parameters. The output of this step is a normalized and constraint-compliant comment string suitable for use as feed content.

### Step 10

The server stores the generated comment as content for a user feed. The input of this step is the validated comment string from Step 9 and the user and context metadata from Step 4. The server creates a feed-content record containing fields such as user identifier, comment text, creation timestamp, and a reference to the underlying experiential information and prompt sentence. The server inserts this record into a storage subsystem, such as a relational table or a document collection, using a database driver. The output of this step is a persistent feed-content entry that can be retrieved by feed-generation processes.

### Step 11

The server formats feed data for delivery to the terminal. The input of this step is the stored feed-content entry from Step 10, and possibly additional feed entries selected according to a retrieval policy. The server transforms each entry into a display-ready structure, including fields for the comment text, formatted timestamp, and identifiers for interaction controls. The server aggregates these structures into a feed data set and serializes it into a hierarchical format appropriate for network transmission. The output of this step is a serialized feed-data payload representing one or more feed items.

### Step 12

The server transmits the feed-data payload to the terminal. The input of this step is the serialized feed data from Step 11 and the network session information corresponding to the user's terminal. The server embeds the feed data into an HTTP response message and sends it via HTTPS using the network interface. The output of this step is a network response containing the feed data, delivered to the terminal.

### Step 13

The terminal receives and parses the feed data and updates the displayed user feed. The input of this step is the HTTP response from Step 12. The terminal extracts and deserializes the feed-data payload into in-memory objects representing individual feed items. The terminal inserts the new feed item corresponding to the generated comment at an appropriate position in its feed list, typically at the top. The terminal then uses its UI framework to render or refresh the feed display so that the generated comment appears on the screen, for example, “Today the sky feels dark and the air is dry.” The output of this step is an updated visual feed presented to the user, reflecting the automatically generated comment based on the user's experiential selections.

### Application Example 2

Description follows regarding a flow of the specific processing in an Application Example 2. The units of the system described below are implemented by the data processing device 12 and the smart device 14. The data processing device 12 is called a “server” and the smart device 14 is called a “terminal”.

Conventional computer-implemented systems for distributing environment-related information, such as weather or ambient conditions, generally retrieve structured data from a data source and present it as raw numerical values or fixed textual descriptions. These systems suffer from several technical limitations in terms of data processing, user interaction, and network utilization.
First, conventional systems typically lack an integrated processing pipeline that combines objective environmental information with subjective user input and machine-generated natural language. As a result, the processor in such systems merely formats and forwards static data, without performing higher-level, context-aware transformations. This leads to inefficient use of processing resources, because the same low-level data must be repeatedly interpreted by each end user or by separate applications.
Second, conventional systems do not systematically generate or control prompt sentences for a generative AI model within the server-side processing logic. In many existing architectures, if text generation is used at all, it is invoked in an ad hoc manner, with prompt content constructed on the client or manually. This results in inconsistent prompts, unstable output quality, and increased latency, because there is no unified mechanism within the processor to assemble, optimize, and reuse prompt sentences based on structured environmental information and user selections.
Third, conventional systems do not integrate emotion estimation as a first-class data-processing step within the server. User emotion is either ignored or handled as opaque metadata. Without server-side estimation of emotion types and intensities, conventional systems cannot systematically adjust the generated text or the data processing path. This limits the ability of the processor to perform meaningful pre-processing and conditioning of inputs to the generative AI model, and prevents the system from adapting its output in a controlled and repeatable way.
Fourth, conventional systems generally treat the generated text, if any, as a final product and do not apply server-side summarization or other information reduction techniques in a coordinated manner. Long or redundant generated text is transmitted directly to terminal devices or external services, increasing network traffic and client-side processing overhead. This degrades system scalability and responsiveness, particularly when large numbers of users simultaneously request content.
Fifth, conventional systems lack an integrated mechanism to manage the entire lifecycle of generated content—from acquisition of environmental information and subjective selections, through prompt sentence construction and generative AI invocation, to post-processing, storage with associated metadata, and conversion into publication formats for multiple distribution channels. As a consequence, content storage is fragmented, and it is difficult for the processor to maintain consistent associations among environmental information, user information, emotion information, and generated text across different modules.

Accordingly, there is a need for a computer-implemented system and server-side processing architecture that: (i) programmatically combines environmental information, subjective user information, and emotion information; (ii) generates and manages prompt sentences for a generative AI model in a structured manner; (iii) applies summarization and information processing to generated text on the server; (iv) stores simplified character information in association with environmental and user information; and (v) converts such simplified character information into publication formats for efficient distribution via communication networks. Such a system should improve the technical operation of the server and networked terminals by reducing data volume, stabilizing generated text quality, and providing a coherent end-to-end processing flow that can be executed automatically by the processor.

The specific processing by the specific processing unit 290 of the data processing device 12 in Application Example 2 is realized by the following means.

The present invention provides a server comprising a processor configured to acquire environmental information from an environmental information storage unit, generate visual symbols and character information representing the environmental information, obtain position information and subjective selection items from a terminal device, estimate emotion information based on the subjective selection items and user information, generate a prompt sentence that instructs a generative AI model to generate character information on the basis of the environmental information, the subjective information, and the emotion information, input the prompt sentence into the generative AI model and acquire generated character information, execute information processing including summarization processing on the generated character information to produce simplified character information, store the simplified character information in association with the environmental information and the user information in a storage unit, generate display information including the simplified character information and transmit the display information to the terminal device, and convert the simplified character information into a publication format and transmit the simplified character information in the publication format to an information distribution infrastructure via a communication network. This enables the server to implement a unified, machine-controlled processing pipeline that transforms raw environmental data and user selections into compact, context-aware textual content, reduces network and client-side processing loads by performing summarization and formatting on the server, stabilizes the behavior of the generative AI model through structured prompt sentence generation, and maintains consistent associations among environmental information, user information, emotion information, and generated content for efficient storage and multi-channel distribution.

The term “environmental information” refers to machine-readable data indicative of physical conditions in an environment, including at least one of temperature, humidity, precipitation, wind, illumination, or other measurable state variables acquired from an information source or sensor system.
The term “environmental information storage unit” refers to a hardware or software data repository, such as a memory or database, that stores environmental information in association with identifiers enabling retrieval by a processor.
The term “visual symbol” refers to a graphical representation generated by the processor on the basis of environmental information, such as an icon, pictogram, or other visual indicator corresponding to a state of the environment.
The term “character information” refers to text data represented as a sequence of characters or strings, expressing environmental information, subjective information, emotion information, or combinations thereof in a human-readable linguistic form.
The term “position information” refers to data indicating a geographic location of a terminal device or user, such as coordinates, region identifiers, or other location descriptors obtained from a positioning mechanism.
The term “terminal device” refers to an information processing apparatus operated by a user, such as a portable device, a stationary device, or any computing device capable of communicating with the server via a communication network.
The term “selection item” refers to an option or entry presented by a user interface for accepting subjective information from a user, the option or entry being selectable by user input and representing a qualitative or categorical value.
The term “subjective information” refers to user-specific, perception-based information related to the environment, such as a user's feeling about brightness, humidity, comfort, or other personal impressions, which is indicated by at least one selection item or user input.
The term “user information” refers to data identifying or characterizing a user, including at least one of a user identifier, profile attribute, usage history, or any information enabling association of processing results with a particular user.
The term “emotion information” refers to data representing an estimated emotional state of a user, including at least one of an emotion type and an emotion intensity, determined on the basis of subjective information, user information, or other input data.
The term “emotion analysis function” refers to a computational function executed by the processor, or by an external processing service invoked by the processor, that analyzes input data to estimate emotion information such as emotion type or intensity.
The term “generative AI model” refers to a machine learning model or other generative information processing model configured to receive a prompt sentence as input and output character information generated according to statistical or learned language patterns.
The term “prompt sentence” refers to character information constructed by the processor and supplied as an input instruction to a generative AI model, the prompt sentence specifying at least part of the content, style, or constraints of character information to be generated.
The term “template information” refers to predefined character data structures, including placeholders for variables, that are stored in a memory and selected by the processor to assist in constructing a prompt sentence based on associated environmental information, subjective information, or emotion information.
The term “summarization processing” refers to an automated information processing operation applied to character information to produce simplified character information, the operation including removal of redundancy, reduction of length, or extraction of salient content.
The term “simplified character information” refers to character information that has been processed by summarization processing or other information reduction techniques, such that the information is more concise while preserving at least essential semantics.
The term “storage unit” refers to any memory resource, such as a volatile memory, non-volatile memory, or database system, configured to store environmental information, user information, emotion information, prompt sentences, or character information in an addressable manner.

The term “display information” refers to data generated by the processor for presentation on a terminal device, the data including at least one of simplified character information, visual symbols, layout instructions, or user interface elements.

The term “publication format” refers to a data structure or encoding form, including at least one of a markup structure, a message format, or a protocol-compliant packet, suitable for transmitting simplified character information to an external information distribution infrastructure.

The term “communication network” refers to a wired or wireless data communication infrastructure, including at least one of a local network, a wide-area network, or the internet, over which data is transmitted between the server, terminal devices, and external systems.
The term “information distribution infrastructure” refers to a computing system or platform, such as a content distribution server, a service platform, or an application service, that is configured to receive character information in a publication format and make the information available to one or more users.

In one embodiment, a server, a terminal, and a user cooperate to implement the claimed system. The server includes a processor, a main memory, a nonvolatile storage device, a network interface, and one or more graphics-capable interfaces. The terminal includes a processor, a memory, a display, user input hardware (touch panel, buttons, microphone), and a positioning unit such as a global positioning receiver. The user operates the terminal to provide subjective selections and to view generated information.
Server uses a general-purpose operating system and executes application software including a web service component, a data management component, an emotion analysis component, a prompt generation component, a generative AI interface component, and a summarization component. Server may employ a runtime environment such as a scripting runtime, and a database management system for implementing the storage unit and the environmental information storage unit. Server stores environmental information in a structured format including fields for a location identifier, a timestamp, physical environmental parameters (for example, temperature, humidity, precipitation state, wind speed, illuminance), and corresponding visual symbol identifiers.
Terminal executes an application, for example implemented in a cross-platform framework, that communicates with the server via a communication network using a request-response protocol such as HTTP over a secure transport. Terminal obtains position information from its positioning hardware or from an operating system location service and transmits this position information to the server. Terminal also receives display information, including visual symbols and character information, from the server and renders such information on the display using a graphical user interface library.
Server uses the position information received from the terminal to query the environmental information storage unit. In one embodiment, server sends an API request to an external data service providing environmental measurements and then stores the resulting environmental information in the environmental information storage unit, which may be implemented as a time-series table in a database. Server maps numerical environmental codes, such as weather codes or illumination levels, to visual symbol identifiers by referencing a symbol mapping table stored in memory. For instance, server maps a code representing clear sky to a “sun” icon and a code representing overcast sky to a “cloud” icon. Server then constructs character information describing the environmental information, such as “Cloudy, 24 degrees, humidity 70 percent,” by formatting the numerical values into textual templates.
Server generates display information that combines the visual symbol identifiers and the character information with a data structure describing selection items. These selection items correspond to subjective information, such as “brightness of the sky: very bright/bright/cloudy/dark” and “feeling of humidity: dry/comfortable/wet.” Server transmits this display information to the terminal. Terminal renders the visual symbols and text on the display and presents the selection items as selectable user interface elements, such as radio buttons or sliders. User interacts with these elements and selects values that represent user-perceived conditions. Terminal then constructs a message comprising the selected subjective information, a user identifier or account token, and optional context data (such as previous selections or language preference), and transmits the message to the server. Server receives the subjective information and the user information and estimates emotion information by executing an emotion analysis function. In one embodiment, server represents each selection item and optional user text as a feature vector, for example using one-hot encoding of selection categories, scalar normalization of intensities, and embedding of text tokens. Server then inputs these feature vectors into an emotion classifier implemented as a neural network. The neural network may be a multilayer perceptron with an input layer corresponding to the concatenated features, one or more hidden layers employing nonlinear activation functions such as rectified linear units, and an output layer producing probabilities over emotion types such as “joy,” “calm,” “sadness,” and “irritation.” Server computes an emotion type by selecting the maximum-probability output and computes an emotion intensity by mapping the probability or a separate regression output to a scalar intensity value. Server thereby generates emotion information that includes both an emotion type and an intensity. By executing this analysis on the server, the system centralizes emotion estimation and avoids inconsistent classification across different client devices.
Server then generates a prompt sentence that instructs a generative AI model to generate character information. Server builds the prompt sentence using a prompt generation component that selects template information from a plurality of templates stored in memory. Each template associates certain environmental conditions, subjective information, and emotion information with a text skeleton containing placeholders. For example, when the brightness selection is “cloudy,” the humidity feeling is “wet,” and the emotion type is “neutral,” server may select a template such as:
“User selected ‘{brightness}’ for the brightness of the sky and ‘{humidity}’ for the feeling of humidity. The user's emotion is ‘{emotion}’. Please generate a short, natural-sounding weather comment that reflects this perception.”
Server replaces the placeholders {brightness}, {humidity}, and {emotion} with the specific values, thereby constructing a concrete prompt sentence. Other prompt sentence examples include:
“The user selected the sky brightness as ‘very bright’ and the humidity as ‘dry,’ and the user's emotion is ‘joy.’ Please generate a brief cheerful comment suitable for posting on a social network.”
“The user's emotion is ‘a little depressed’ and the weather is ‘cloudy.’ Please suggest one or two short personalized activities or content items to improve the user's mood.”
By generating prompt sentences on the server in a structured manner, the system controls input to the generative AI model, reduces prompt variability, and improves the stability and predictability of generated outputs.
Server then provides the prompt sentence to a generative AI model. In one embodiment, the generative AI model is a language model based on a transformer neural network architecture. The transformer includes an embedding layer that converts input tokens (prompt words and symbols) into dense vectors, multiple self-attention layers that compute context-dependent representations of each token, and a feed-forward layer that outputs probability distributions over possible next tokens. Server tokenizes the prompt sentence, maps tokens to embedding indices, and transmits the resulting sequence to the generative AI model. Within the model, attention mechanisms compute attention weights between tokens, and the model iteratively predicts subsequent tokens according to learned parameters. During training, such a model is trained on large corpora of text using a loss function such as cross-entropy between predicted tokens and ground-truth tokens, and the model parameters (weights and biases) are updated by a gradient-based optimization algorithm such as stochastic gradient descent with adaptive learning rate. Although training may be performed offline, this description clarifies the internal structure and operation of the generative AI model.
Server sends the prompt sentence to the generative AI model via an interface component that handles communication details such as formatting requests and decoding responses. Server receives generated character information from the model, typically as a sequence of tokens that are converted back into text. Server then applies summarization processing. In one embodiment, server employs an extractive summarization algorithm that represents sentences of the generated text as term vectors and computes sentence scores based on term frequency, inverse document frequency, and positional weighting. Server selects sentences with scores above a threshold, reorders them if necessary, and constructs simplified character information that tends to be shorter and more focused than the raw output. In another embodiment, server performs abstractive summarization by invoking a secondary model configured specifically for summarizing text, again using a prompt sentence that instructs the model to condense the generated text into a specified maximum number of characters.
By executing summarization on the server, the system reduces the length and redundancy of character information before transmitting it over the communication network. This reduces communication load, accelerates content delivery to the terminal, and decreases processing requirements on the terminal. Moreover, by standardizing the summarization process in one place, the server ensures consistent output quality across different terminals.
Server stores the simplified character information in association with environmental information and user information in a storage unit. In one embodiment, server maintains a relational or document-oriented table where each record includes a user identifier, a timestamp, a location identifier, environmental information identifiers, subjective information values, emotion information (emotion type and intensity), the prompt sentence used, and the simplified character information. This structured storage enables server to perform efficient queries such as “retrieve all comments for a given location and weather condition” or “analyze how emotion correlates with particular environmental situations.” By designing the data schema to capture the full context of each generated text item, the system improves data management and allows downstream analytics or model retraining with minimal additional processing.
Server also generates display information including the simplified character information and any visual symbols and transmits this display information to the terminal. Terminal receives the display information and updates the user interface accordingly. In some embodiments, terminal shows the simplified character information along with the visual symbol and emotion indicator, such as a labeled icon representing “joyful” or “calm.” User can thus easily interpret both the environmental state and the system's interpretation of the user's emotion.
Server further converts the simplified character information into a publication format suitable for transmission to an external information distribution infrastructure. In one embodiment, server maps the text and metadata into a markup structure required by a web-based content aggregation system or a social feed service, including fields for content body, content type, tags, and timestamps. Server then transmits this publication format via the communication network using a protocol such as REST over HTTPS. The information distribution infrastructure receives the data, stores it in its own data structures, and makes it available for retrieval and display to other users. Because the server performs the format conversion and transmission, terminals are relieved from the complexity of dealing with heterogeneous external platforms.
This architecture provides technical effects that go beyond a mere automation of human writing tasks. Server improves processing efficiency by structuring prompt sentence generation and by pre-processing inputs to the generative AI model, which reduces entropy and narrows the generation space, leading to faster convergence of the model's decoding step and lower average token generation counts for each request. Server reduces communication traffic by performing summarization and by limiting the size of character information transmitted to terminals and external platforms, which is particularly significant in environments where many users simultaneously submit requests.
Additionally, server improves accuracy and consistency of generated content by integrating emotion estimation and environmental context directly into the prompt sentence. Instead of relying on ad hoc, client-side prompt assembly that might omit relevant data or format it inconsistently, server uses deterministic template selection based on structured inputs. This non-conventional combination of environmental information, subjective information, and emotion information yields text outputs that better match user perception and are technically more uniform than texts produced by isolated client devices.
Server also applies non-standard processing sequences that differ from simple data retrieval and display. For example, server first transforms structured sensor-like inputs and categorical selections into a high-dimensional feature representation for emotion analysis, then merges the resulting emotion information into a prompt structure, then performs generative decoding, and finally applies summarization and storage with full metadata linkage. This ordered pipeline is designed to minimize redundant computation and to maintain traceability from each generated text back to its environmental and subjective origin, which substantially improves data management and error analysis.
In another embodiment, server uses a rule-based component in conjunction with the generative AI model. For particular combinations of environmental information and subjective information, server may bypass or constrain generative output using predefined phrases or post-processing rules. For instance, if the environmental information indicates extreme weather conditions and the emotion intensity exceeds a threshold, server can enforce the inclusion of safety-related phrases. This hybrid approach leverages both learned generative capabilities and explicit rule-based safety constraints, improving robustness and technical reliability compared to a purely manual or purely generative approach.
In a further embodiment, server dynamically adjusts parameters of the generative AI model interface, such as temperature or maximum output length, based on environmental conditions and network load. For example, server may lower the temperature parameter when the emotion type is “calm” to produce more deterministic outputs and reduce processing overhead, or shorten maximum output length when network congestion is detected to ensure timely responses. These adjustments are based on machine-readable metrics and are executed by the processor, thereby providing an adaptive behavior at the computer-architecture level that optimizes resource usage.
Terminal may also implement alternative user interfaces, such as voice input where user speaks subjective information and emotion. Terminal converts the audio into text using a speech recognition engine and sends the text to the server. Server then maps the recognized phrases into selection items or uses them directly as part of the prompt sentence. This variation shows that the same server-side pipeline can support different input modalities while maintaining the same internal data structures and technical advantages.
In another embodiment, server deploys multiple generative AI models with different architectures or training corpora. Server can select a model specializing in short comments for mobile display, or a model focusing on detailed descriptions for desktop interfaces. The selection can be based on user device type information received from the terminal. Server then executes the same overall method—prompt generation, generative inference, summarization, storage, and publication—but with model selection logic that further improves responsiveness and appropriateness of the generated content.
Because the described system integrates specific data structures (context-rich records associating environmental information, subjective information, emotion information, prompt sentences, and simplified character information), specific processing modules (emotion analysis neural networks, prompt template selection, transformer-based generation, summarization algorithms), and specific control flows (centralized server-side generation, summarization prior to transmission, and structured publication formatting), the system achieves technical improvements in processing speed, communication efficiency, data management, and output consistency. These improvements arise from the concrete arrangement and interaction of computing components, and not from a mere abstract idea or a generic business method.

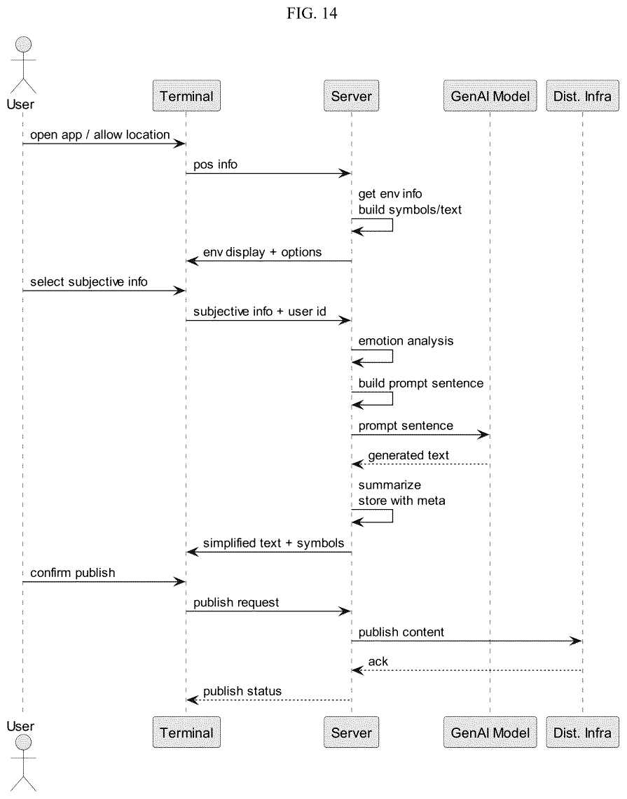

The following describes the processing flow using FIG. 14.

### Step 1

User operates the terminal to start an application that communicates with the server.
User provides permission for location acquisition when prompted by the terminal's operating system.
Input: User operation (app launch and permission grant).
Output: Terminal state in which the application is active and authorized to access position information.

### Step 2

Terminal acquires position information from a positioning unit or OS location service.
Terminal converts raw latitude and longitude values into a structured record, for example including coordinates, timestamp, and device identifier.
Terminal transmits this structured position information to the server via a network interface using a request protocol.
Input: Signals from the positioning hardware and OS APIs.
Data processing: Terminal reads raw sensor data, filters noise, converts it into standardized floating-point coordinates, and encapsulates the coordinates in a message format.
Output: A position information message sent to the server.

### Step 3

Server receives the position information message through a network interface and parses the coordinates and metadata.
Server queries an environmental information source, such as an environmental information storage unit or external data service, by using the coordinates as query parameters.
Server receives raw environmental data including at least temperature, humidity, and condition codes.
Input: Position information (coordinates and timestamp).
Data processing: Server constructs a query, sends it to the environmental source, and converts the returned data into internal data structures with typed fields.
Output: Structured environmental information stored in memory.

### Step 4

Server converts condition codes in the environmental information into visual symbol identifiers by referencing a symbol mapping table.
Server formats the environmental parameters into character information using textual templates, such as concatenating temperature and humidity values with unit labels.
Input: Structured environmental information.
Data processing: Server performs table lookup to map codes to symbol identifiers and executes string formatting operations to create descriptive text.
Output: Visual symbol identifiers and character information representing the current environment.

### Step 5

Server generates display information that includes the visual symbols, the character information, and a set of selection items for subjective information, such as “brightness of the sky” and “feeling of humidity.”
Server structures these selection items as machine-readable options with identifiers and labels.
Server transmits the display information to the terminal via the communication network.
Input: Visual symbol identifiers, character information, and a predefined list of selection item definitions.
Data processing: Server assembles these elements into a display data object, serializes it, and prepares it for network transmission.
Output: Display information message sent to the terminal.

### Step 6

Terminal receives the display information and decodes the visual symbols, text, and selection items.
Terminal renders a graphical user interface that shows the symbols and character information and presents the selection items as interactive controls.
Input: Display information message from the server.
Data processing: Terminal parses the data, maps symbol identifiers to icon assets, and constructs interface elements according to layout rules.
Output: A displayed user interface that allows user selection of subjective information.

### Step 7

User observes the displayed environmental information and interacts with the selection items.
User selects values for subjective information, for example choosing “cloudy” for brightness and “wet” for feeling of humidity.
User optionally provides additional input, such as free-text notes or an explicit emotion label.
Input: Displayed user interface on the terminal.
Data processing: User evaluates the environmental situation and performs touch or other input actions; this is a human cognitive process rather than machine computation.
Output: User selections and optional additional inputs registered in the terminal's application state.

### Step 8

Terminal collects the subjective information values and user identifier from its local storage or session data.
Terminal constructs a message that includes the subjective selections, optional free-text, and user identifier.
Terminal transmits this message to the server via the communication network.
Input: User selections, optional notes, and user identifier.
Data processing: Terminal encodes categorical selections as symbolic or numeric values, attaches identifiers, and serializes the data into a message format.
Output: Subjective information message sent to the server.

### Step 9

Server receives the subjective information message and parses the selection values and user information.
Server transforms the subjective information into feature vectors, for example by encoding categorical choices as one-hot vectors and normalizing any continuous values.
Server retrieves additional context about the user, such as previous selection patterns, from the storage unit if available.
Input: Subjective information message and stored user context.
Data processing: Server merges new selection data with historical context to form a unified feature representation suitable for emotion analysis.
Output: Feature vectors representing the user's subjective state and context.

### Step 10

Server executes an emotion analysis function that estimates emotion information based on the feature vectors.
Server inputs the feature vectors into an emotion classifier, such as a neural network with predefined weights, and computes probabilities for multiple emotion types.
Server determines an emotion type by selecting the type with the highest probability and calculates an emotion intensity, for example by mapping the probability to a scalar value.
Input: Feature vectors derived from subjective information and user context.
Data processing: Server performs matrix multiplications and nonlinear activations within the classifier to propagate signals through layers and computes output probabilities and intensities.
Output: Emotion information containing at least one emotion type and one intensity value.

### Step 11

Server selects a prompt template from a set of stored templates based on the environmental information, subjective information, and emotion information.
Server generates a prompt sentence by inserting specific values such as brightness selection, humidity feeling, and emotion type into the selected template.
Server optionally appends constraints to the prompt sentence, such as language and length restrictions.
Input: Environmental information, subjective information, emotion information, and template definitions.
Data processing: Server evaluates conditions for template selection, performs string substitution operations, and concatenates additional instruction phrases.
Output: A concrete prompt sentence prepared for the generative AI model.

### Step 12

Server encodes the prompt sentence into a token sequence according to the vocabulary of the generative AI model.
Server invokes an interface to the generative AI model and submits the token sequence as input, along with generation parameters such as maximum token count and temperature.
Server receives a sequence of output tokens from the generative AI model representing generated character information.
Input: Prompt sentence and model configuration parameters.
Data processing: Server performs tokenization, transmits the tokens to the generative AI model, and decodes the returned tokens back into text.
Output: Generated character information as a continuous text string.

### Step 13

Server evaluates the length and structure of the generated character information to determine whether summarization is required.
Server segments the text into sentences and computes scores for each sentence based on metrics such as term frequency and positional weight.
Server selects one or more sentences with the highest scores and concatenates them to create simplified character information, or alternatively calls a summarization model with a summarization instruction.
Input: Generated character information.
Data processing: Server performs natural language processing tasks including tokenization, term counting, scoring, selection, and optional secondary generation.
Output: Simplified character information that is shorter and more focused than the original.

### Step 14

Server associates the simplified character information with environmental information, subjective information, emotion information, prompt sentence, and user identifier.
Server writes this combined record into a storage unit, using a schema that allows efficient retrieval based on any of these fields.
Input: Simplified character information and related metadata.
Data processing: Server constructs a record with keyed fields, validates data consistency, and commits the record to persistent storage.
Output: A stored entry that captures the full context of the generated text.

### Step 15

Server generates display information for the terminal that includes the simplified character information, associated visual symbols, and optionally the emotion type.
Server serializes this display information and transmits it to the terminal as a response to the subjective information message or as a subsequent push.
Input: Simplified character information, visual symbol identifiers, and emotion information.
Data processing: Server composes these elements into a layout-ready representation, encodes it, and schedules transmission via the network interface.
Output: Display information message sent to the terminal.

### Step 16

Terminal receives the display information message and parses the simplified text, symbols, and any emotion indicators.
Terminal updates the user interface to show the simplified character information and visual symbols, and may show an indication that the content is ready for publication.
Input: Display information message from the server.
Data processing: Terminal decodes the message, maps symbols to graphical assets, and refreshes interface components on the display.
Output: A rendered screen that presents the generated and simplified text to the user.

### Step 17

User reviews the simplified character information and confirms whether to publish it to an external information distribution infrastructure.
User may optionally edit the text slightly using an input control on the terminal before confirming.
Input: Displayed simplified character information on the terminal.
Data processing: User visually inspects and optionally modifies the text; this is a human evaluation process.
Output: A publication decision and optionally an edited version of the text captured within the terminal.

### Step 18

Terminal constructs a publication request that includes the text deemed final by the user, the user identifier, and any required metadata such as publication flags or target platform identifiers.
Terminal sends this publication request to the server via the communication network.
Input: User's final text, user identifier, and publication parameters.
Data processing: Terminal merges these fields into a request structure, encodes it, and dispatches it to the server.
Output: Publication request message transmitted to the server.

### Step 19

Server receives the publication request and updates the stored record to reflect the final text and publication status.
Server converts the text and metadata into a publication format required by the target information distribution infrastructure, such as a structured content object with standardized fields.
Server transmits the publication format to the information distribution infrastructure over the communication network using the appropriate protocol.
Input: Publication request message and stored record.
Data processing: Server merges new text with stored metadata, reformats the data according to the external platform's schema, and performs authenticated network transmission.
Output: A published content entry on the information distribution infrastructure and an updated record in the server storage.

### Step 20

Terminal optionally requests or receives a list of published entries from the server to display a feed of content.
Terminal presents this feed, which may include the user's own new entry and entries from other users, using scrollable interface elements.
Input: Feed data from the server containing multiple simplified character information items and associated symbols.
Data processing: Terminal parses the feed structure, instantiates user interface elements for each entry, and manages layout and scrolling behavior.
Output: A feed view on the terminal showing multiple generated and published weather-related comments.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Moreover, although the processing by the data processing system 10 described above was executed by the specific processing unit 290 of the data processing device 12 or by the control unit 46A of the smart device 14, the processing may be executed by a specific processing unit 290 of the data processing device 12 and a control unit 46A of the smart device 14. Moreover, the specific processing unit 290 of the data processing device 12 acquires and collects information needed for processing from the smart device 14 or from an external device or the like, and the smart device 14 acquires and collects information needed for processing from the data processing device 12 or from an external device or the like.

For example, a collection unit is implemented by the control unit 46A of the smart device 14 and/or by the specific processing unit 290 of the data processing device 12. For example, an acquisition unit acquires number-of-steps data using the camera 42 and/or the communication I/F 44 of the smart device 14, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the output device 40 of the smart device 14 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart device 14.

### Second Exemplary Embodiment

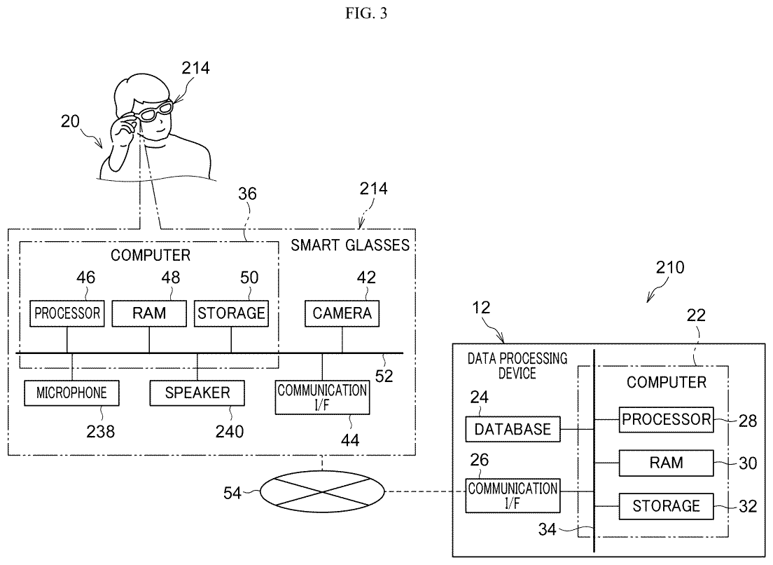

FIG. 3 illustrates an example of a configuration of a data processing system 210 according to a second exemplary embodiment.

As illustrated in FIG. 3, the data processing system 210 includes a data processing device 12 and smart glasses 214. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart glasses 214 include a computer 36, a microphone 238, a speaker 240, a camera 42, and a communication I/F 44. The computer 36 includes a processor 46, RAM 48, and storage 50. The processor 46, the RAM 48, and the storage 50 are connected to a bus 52. The microphone 238, the speaker 240, the camera 42, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

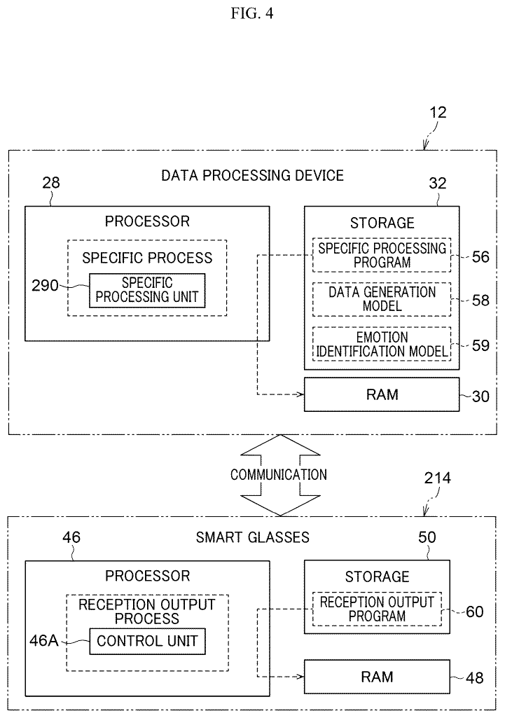

FIG. 4 illustrates an example of relevant functions of the data processing device 12 and the smart glasses 214. As illustrated in FIG. 4, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart glasses 214. A reception and output program 60 is stored in the storage 50. The processor 46 reads the reception and output program 60 from the storage 50 and in the RAM 48 executes the read reception and output program 60. The reception and output processing is implemented by the processor 46 operating as the control unit 46A according to the reception and output program 60 executed in the RAM 48. Note that a configuration may be adopted in which the smart glasses 214 include a data generation model and an emotion identification model similar to the data generation model 58 and the emotion identification model 59, and processing similar to the specific processing unit 290 is performed using these models.

Next, description follows regarding the specific processing by the specific processing unit 290 of the data processing device 12. The units of the system described below are implemented by the data processing device 12 and the smart glasses 214. In the following description the data processing device 12 is called a “server”, and the smart glasses 214 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the smart glasses 214. The control unit 46A in the smart glasses 214 outputs the specific processing result to the speaker 240. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the smart glasses 214, the processing may be executed by a specific processing unit 290 of the data processing device 12 and a control unit 46A of the smart glasses 214. Moreover, the specific processing unit 290 of the data processing device 12 acquires and collects information needed for processing from the smart glasses 214 or from an external device or the like, and the smart glasses 214 acquires and collects information needed for processing from the data processing device 12 or from an external device or the like.

For example, the collection unit is implemented by the control unit 46A of the smart glasses 214 and/or by the specific processing unit 290 of the data processing device 12. For example, an acquisition unit acquires number-of-steps data using the camera 42 and/or the communication I/F 44 of the smart glasses 214, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 of the smart glasses 214 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart glasses 214.

### Third Exemplary Embodiment

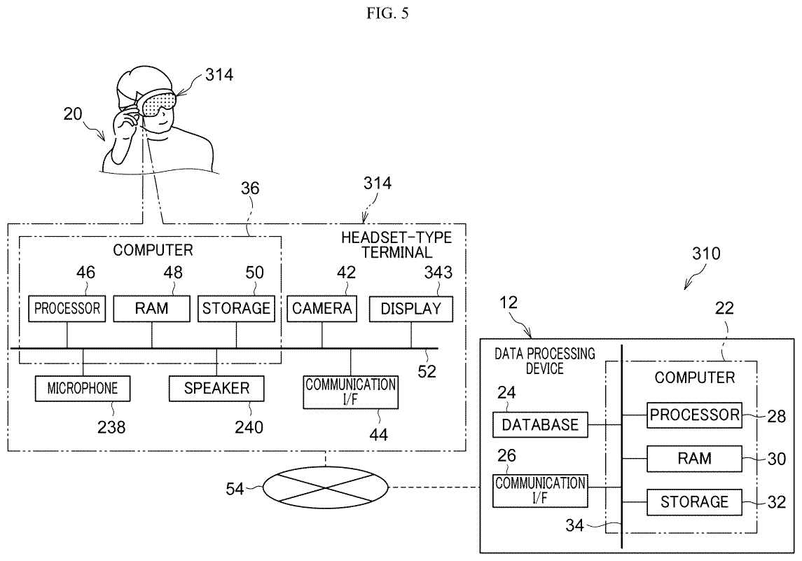

FIG. 5 illustrates an example of a configuration of a data processing system 310 according to a third exemplary embodiment.

As illustrated in FIG. 5, the data processing system 310 includes a data processing device 12 and a headset-type terminal 314. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The headset-type terminal 314 includes a computer 36, a microphone 238, a speaker 240, a camera 42, a communication I/F 44, and a display 343. The computer 36 includes a processor 46, RAM 48, and storage 50. The processor 46, the RAM 48, and the storage 50 are connected to a bus 52. The microphone 238, the speaker 240, the camera 42, the display 343, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

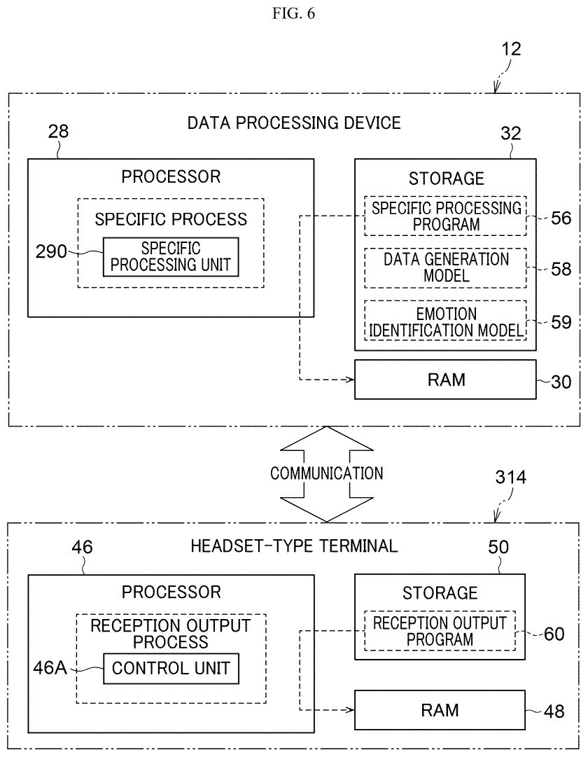

FIG. 6 illustrates an example of relevant functions of the data processing device 12 and the headset-type terminal 314. As illustrated in FIG. 6, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the headset-type terminal 314. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the headset-type terminal 314. In the following description the data processing device 12 is called a “server”, and the headset-type terminal 314 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the headset-type terminal 314. In the headset-type terminal 314, the control unit 46A outputs the result of the specific processing to the speaker 240 and the display 343. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL:https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the headset-type terminal 314, the processing may be executed by a specific processing unit 290 of the data processing device 12 and a control unit 46A of the headset-type terminal 314. Moreover, the specific processing unit 290 of the data processing device 12 acquires and collects information needed for processing from the headset-type terminal 314 or from an external device or the like, and the headset-type terminal 314 acquires and collects information needed for processing from the data processing device 12 or from an external device or the like.

For example, the collection unit is implemented by the control unit 46A of the headset-type terminal 314 and/or by the specific processing unit 290 of the data processing device 12. For example, an acquisition unit acquires number-of-steps data using the camera 42 and/or the communication I/F 44 of the headset-type terminal 314, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the display 343 of the headset-type terminal 314 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the headset-type terminal 314.

### Fourth Exemplary Embodiment

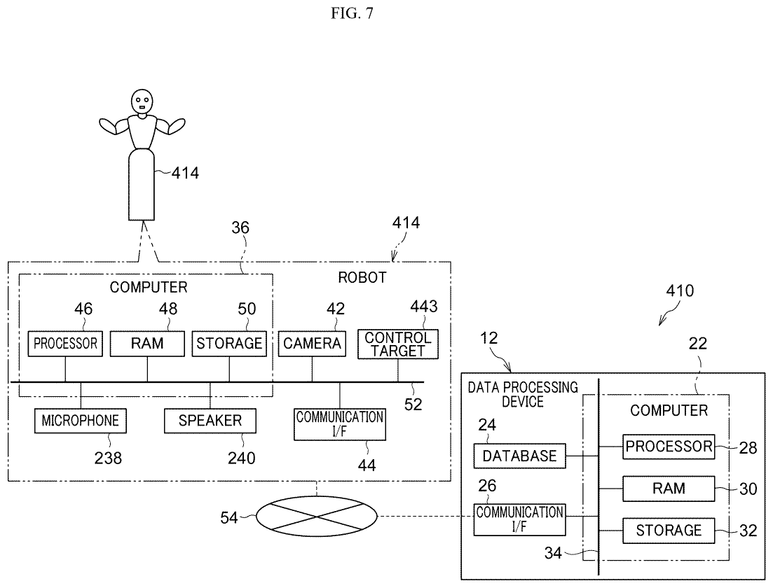

FIG. 7 illustrates an example of a configuration of a data processing system 410 according to a fourth exemplary embodiment

As illustrated in FIG. 7, the data processing system 410 includes a data processing device 12 and a robot 414. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The robot 414 includes a computer 36, a microphone 238, a speaker 240, a camera 42, a communication I/F 44, and a control target 443. The computer 36 includes a processor 46, RAM 48, and storage 50. The processor 46, the RAM 48, and the storage 50 are connected to a bus 52. The microphone 238, the speaker 240, the camera 42, the control target 443, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the robot 414 (for example, with an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

The control target 443 includes a display device, eye LEDs, and motors to drive arms, hands, feet, and the like. The posture and gesture of the robot 414 are controlled by controlling the motors of the arms, hands, feet, and the like. Part of an emotion of the robot 414 can be expressed by controlling these motors. Moreover, a facial expression of the robot 414 can be represented by controlling an illumination state of the eye LEDs of the robot 414.

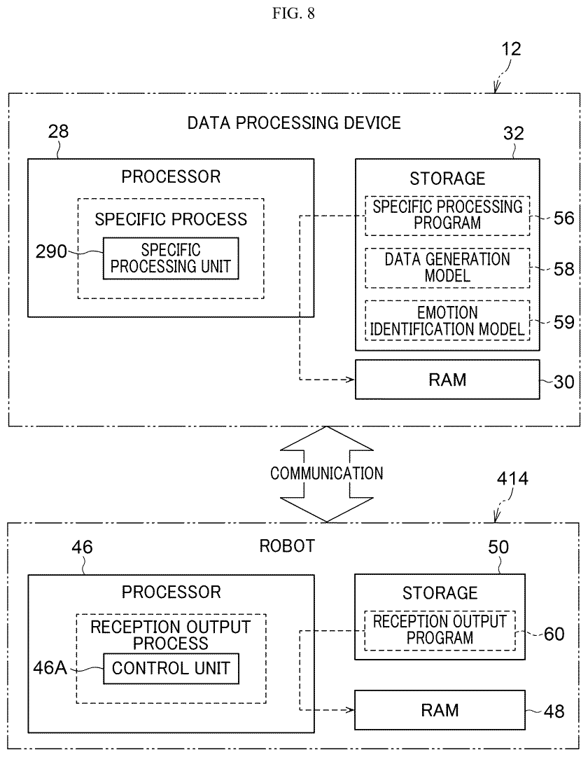

FIG. 8 illustrates an example of relevant functions of the data processing device 12 and the robot 414. As illustrated in FIG. 8, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the robot 414. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the robot 414. In the following description the data processing device 12 is called a “server”, and the robot 414 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the robot 414. In the robot 414, the control unit 46A outputs the result of the specific processing to the speaker 240 and the control target 443. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the robot 414, the processing may be executed by a specific processing unit 290 of the data processing device 12 and a control unit 46A of the robot 414. Moreover, the specific processing unit 290 of the data processing device 12 acquires and collects information needed for processing from the robot 414 or from an external device or the like, and the robot 414 acquires and collects information needed for processing from the data processing device 12 or from an external device or the like.

For example, the collection unit is implemented by the control unit 46A of the robot 414 and/or by the specific processing unit 290 of the data processing device 12. For example, an acquisition unit acquires number-of-steps data using the camera 42 and/or the communication I/F 44 of the robot 414, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the control target 443 of the robot 414 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the robot 414.

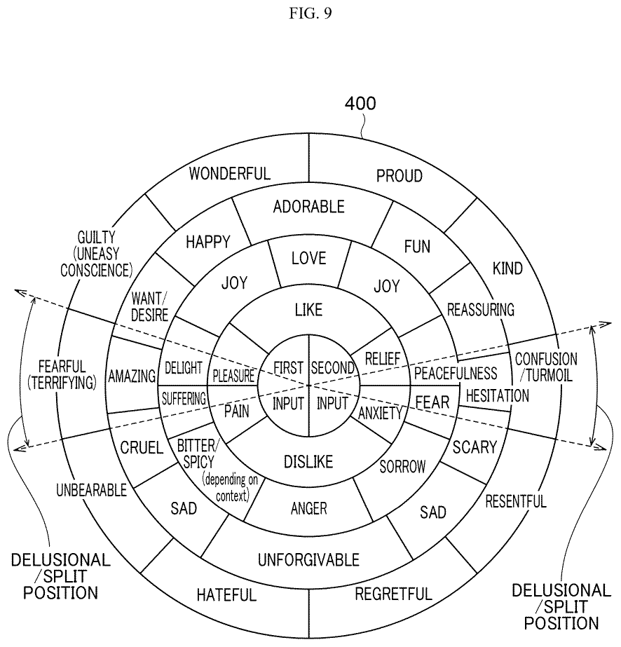

Note that the emotion identification model 59 serves as an emotion engine, and may decide the emotion of a user according to a specific mapping. Specifically, the emotion identification model 59 may decide the emotion of a user according to an emotion map (see FIG. 9) that is a specific mapping. Moreover, the emotion identification model 59 may also decide the emotion of the robot similarly, and the specific processing unit 290 may be configured so as to perform the specific processing using the emotion of the robot.

FIG. 9 is a diagram illustrating an emotion map 400 mapping plural emotions. In the emotion map 400, emotions are arranged in concentric circles that radiate out from the center. Primitive states of emotion are arranged nearer to the center of the concentric circles. Emotions expressing states and actions generated from states of mind are arranged further toward the outside of the concentric circles. Emotions are defined as including both affect and mental states. Emotions generated from reactions occurring in the brain are generally arranged at the left side of the concentric circles. Emotions induced by situational assessment are generally arranged at the right side of the concentric circles. Emotions generated from reactions occurring in the brain that are also emotions induced by situational assessment are generally arranged toward the top and toward the bottom of the concentric circles. Moreover, emotions of “euphoria” are arranged at the upper side of the concentric circles, and emotions of “dysphoria” are arranged at the lower side of the concentric circles. Plural emotions are accordingly mapped in this manner in the emotion map 400 based on a structure giving rise to emotions, and emotions that readily occur at the same time are mapped close to each other.

An example of such emotions is a distribution of emotions in the direction of 3 o'clock on the emotion map 400, generally around a boundary between relief and anxiety. Situational awareness dominates over internal sensations in the right half of the emotion map 400, with an impression of calm.

The inside of the emotion map 400 represents feelings, and the outside of the emotion map 400 represents actions, and so emotions further toward the outside of the emotion map 400 are more visible (are expressed by actions).

Human emotions are based on various balances, such as posture and blood sugar value balances, with a state of dysphoria being exhibited when these balances are far from ideal and a state of euphoria being exhibited when these balances are near to ideal. Even in a robot, a car, a motorbike, or the like, emotions can be thought of as being based on various balances such as orientation and remaining battery balances, with a state called dysphoria being exhibited when these balances are far from ideal and a state called euphoria being exhibited when these balances are near to ideal. An emotion map may, for example, be generated based on the emotion map of Dr. Mitsuyoshi (PhD Dissertation https://ci.nii.ac.jp/naid/500000375379: “Research on the phonetic recognition of feelings and a system for emotional physiological brain signal analysis”, Tokushima University). Emotions belonging to an area called “reaction” where feeling dominates are arranged in the left half of the emotion map. Moreover, emotions belonging to an area called “situation” where situational awareness dominates are arranged in the right half of the emotion map.

There are two types of emotion that facilitate leaning in an emotion map. One is an emotion in the vicinity of the center of negative “penitence” and “reflection” on the situational side. In other words, sometimes a negative “emotion” such as “I don't want to feel this way ever again” and “I don't want to be chided again” is experienced in a robot. Another is a positive emotion in the area of “desire” on the reaction side. In other words, there are times when a positive feeling such as “desire more” and “want to know more” is experienced.

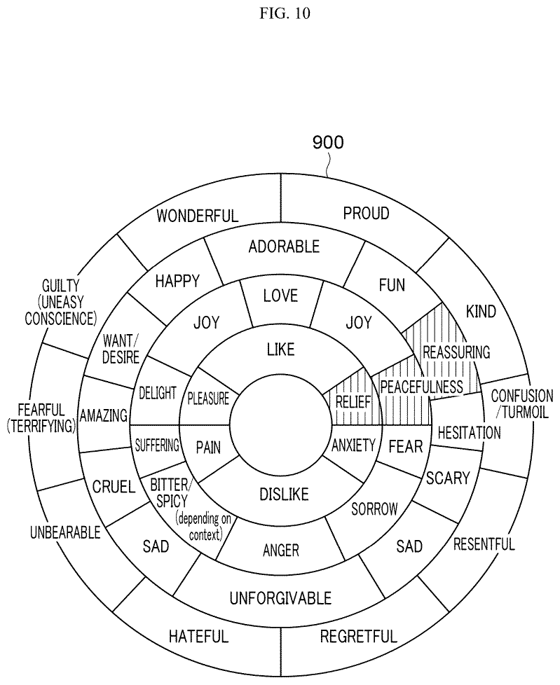

In the emotion identification model 59, user input is input to a pre-trained neural network, and emotion values indicating emotions shown on the emotion map 400 are acquired and the emotions of the user are decided. This neural network is pre-trained based on plural training data sets that each combine a user input with an emotion value indicating an emotion shown on the emotion map 400. The neural network is also trained such that emotions arranged close to each other have values that are close to each other, as in an emotion map 900 illustrated in FIG. 10. In FIG. 10 the plural emotions of “relief”, “peaceful”, and “reassured” are indicated as an example of close emotion values.

Although the system according to the present disclosure has been described mainly as functions of the data processing device 12, the system according to the present disclosure is not limited to being implemented in a server. The system according to the present disclosure may be implemented as a general information processing system. The present disclosure may, for example, be implemented by a software program operating on a personal computer, and may be implemented by an application operating on a smartphone or the like. The method according to the present disclosure may also be supplied to a user in the form of Software as a Service (SaaS).

Although in the exemplary embodiments described above examples are given of embodiments in which the specific processing is performed by a single computer 22, technology disclosed herein is not limited thereto, and distributed processing may be performed for the specific processing, with the specific processing distributed across plural computers including the computer 22. For example, the data generation model 58 may be provided in a device external to the data processing device 12, such that data generation in response to input data is performed in the external device.

Although in the exemplary embodiments described above examples are described of embodiments in which the specific processing program 56 is stored in the storage 32, the technology disclosed herein is not limited thereto. For example, the specific processing program 56 may be stored on a portable, non-transitory, computer readable, storage medium, such as universal serial bus (USB) memory or the like. The specific processing program 56 stored on the non-transitory storage medium is then installed on the computer 22 of the data processing device 12. The processor 28 then executes the specific processing according to the specific processing program 56.

Moreover, the specific processing program 56 may be stored on a storage device, such as a server connected to the data processing device 12 over the network 54, with the specific processing program 56 then being downloaded in response to a request from the data processing device 12 and installed on the computer 22.

Note that there is no need to store the entire specific processing program 56 on the storage device, such as a server connected to the data processing device 12 over the network 54, or to store the entire specific processing program 56 on the storage 32, and part of the specific processing program 56 may be stored thereon.

Hardware resources for executing the specific processing may use various processors as listed below. Examples of processors include, for example, a CPU that is a general-purpose processor that functions as a hardware resource to execute the specific processing by executing software, namely a program. Moreover, the processor may, for example, be a dedicated electronic circuit that is a processor having a circuit configuration custom designed for executing the specific processing, such as a field-programmable gate array (FPGA), a programmable logic device (PLD), or an application specific integrated circuit (ASIC). Memory is inbuilt or connected to each of these processors, and the specific processing is executed by each of these processors using the memory.

The hardware resource that executes the specific processing may be configured from one of these various processors, or may be configured from a combination of two or more processors of the same or different type (for example, a combination of plural FPGAs, or a combination of a CPU and a FPGA). The hardware resource executing the specific processing may be a single processor.

Examples of configurations of a single processor include, firstly, a configuration of a single processor resulting from combining one or more CPU and software, in an embodiment in which this processor functions as the hardware resource for executing the specific processing. Secondly, as typified by a System-on-chip (SOC) or the like, there is also an embodiment that uses a processor realized by a single IC chip to function as an overall system including plural hardware resources for executing the specific processing. Adopting such an approach means that the specific processing is realized using one or more of the various processors described above as hardware resource.

Furthermore, more specifically, an electrical circuit that combines circuit elements such as semiconductor elements or the like may be employed as a hardware structure of these various processors. The specific processing is merely an example thereof. This means that obviously redundant steps may be omitted, new steps may be added, and the processing sequence may be swapped around within a range not departing from the spirit of the present disclosure.

The described content and drawing content illustrated above are a detailed description of parts according to the present disclosure, and are merely examples of the present disclosure. For example, description related to the above configuration, function, operation, and advantageous effects is a description related to examples of the configuration, function, operation, and advantageous effects of parts according to the present disclosure. This means that obviously redundant parts may be eliminated, new elements may be added, and switching around may be performed on the described content and drawing content illustrated above within a range not departing from the spirit of the present disclosure. Moreover, to avoid misunderstanding and to facilitate understanding of parts according to the present disclosure, description related to common knowledge in the art and the like not particularly needing description to enable implementation of the present disclosure is omitted in the described content and drawing content illustrated as described above.

All publications, patent applications and technical standards mentioned in the present specification are incorporated by reference in the present specification to the same extent as if each individual publication, patent application, or technical standard was specifically and individually indicated to be incorporated by reference.

Note that, regarding the above description, the following supplementary notes are further disclosed.

### Example 1

### Supplementary 1

A system comprising a processor,
wherein the processor is configured to generate, based on meteorological-related information stored in an observation information storage unit, graphical representations indicating weather conditions and to construct text information,
wherein the processor is configured to analyze structured information including selection results of a plurality of selectable items representing subjective meteorological sensations, including at least sky brightness and humidity feeling, the structured information being received from a communication terminal device, and to dynamically construct, based on the analysis result, a prompt sentence that serves as an instruction statement for directing a generative AI model to generate text information,
wherein the processor is configured to transmit, to a generative information processing model providing apparatus, a generation request including the prompt sentence, and to obtain text information output from the generative information processing model in response to the generation request,
wherein the processor is configured to apply a summarization processing method to the obtained text information and to generate simplified text information in accordance with predetermined conditions relating to sentence length and expression style, and
wherein the processor is configured to generate response structured information in which the graphical representations, the simplified text information, and the selection results are associated with each other, and to output the response structured information as response data transmittable to the communication terminal device via a communication control unit.

### Supplementary 2

The system according to supplementary 1,
wherein the processor is configured to add, in accordance with the selection results received from the communication terminal device, at least one generation condition relating to a use language, a writing style, a sentence length, or a type of publication medium to the prompt sentence, and to instruct the generative information processing model to generate text information adapted to at least one of social media use, information provision use, or another usage form.

### Supplementary 3

The system according to supplementary 1,
wherein the processor is configured to convert the simplified text information and the graphical representations into a description format for information publication, and to transmit the converted information, via an information communication network, to an external publication information source so that the converted information is distributed as publicly viewable information for other users.

### Application Example 1

### Supplementary 1

A system comprising a processor,
wherein the processor is configured to request acquisition of weather information from a weather information acquisition apparatus on the basis of acquired position information and to acquire current-location weather information from the weather information acquisition apparatus,
wherein the processor is configured to generate visual symbols associated with the acquired weather information and to construct text information on the basis of the visual symbols and the weather information,
wherein the processor is configured to present, to a user, a plurality of sensory information items including at least a sky brightness item and a humidity feeling item and to receive selection results of the sensory information items from the user,
wherein the processor is configured to construct a generation input text on the basis of the weather information and the selection results of the sensory information items, to generate a prompt sentence including the generation input text, and to input the prompt sentence to a generative AI model so as to instruct the generative AI model to generate text information,
wherein the processor is configured to analyze the text information output from the generative AI model, to extract product-type information from the text information, and to acquire product information corresponding to the product-type information from a product information storage apparatus,
wherein the processor is configured to apply summarization processing to the text information output from the generative AI model to generate a simplified explanation text and to construct recommendation information including the explanation text and the product information, and
wherein the processor is configured to transmit the recommendation information to a user terminal.

### Supplementary 2

The system according to supplementary 1,
wherein the processor is configured to cause the user terminal to generate a user interface that displays, as a text display element, the explanation text included in the recommendation information and that displays, in a list format or a catalog format, the product information included in the recommendation information.

### Supplementary 3

The system according to supplementary 1,
wherein the processor is configured to dynamically change contents of the prompt sentence on the basis of the selection results of the sensory information items and the weather information, and to control a type of the text information to be generated by the generative AI model and an extraction accuracy of the product-type information.

### Example 2

### Supplementary 1

A system comprising a processor,
wherein the processor is configured to
cause a terminal to display an input interface that receives a user operation for selecting experiential information, and to acquire structured information including experiential information selected by the user from the terminal,
analyze the experiential information included in the structured information, generate descriptive text representing the experiential information, and generate a prompt sentence including the descriptive text and generation conditions for instructing a generative AI model to generate text information in accordance with the generation conditions,
transmit a request including the prompt sentence to the generative AI model and acquire automatically generated text information from the generative AI model based on the prompt sentence,
store the automatically generated text information as content for a user feed and convert the content for the user feed into feed data displayable on the terminal, and
transmit the feed data to the terminal and cause the terminal to display the content for the user feed.

### Supplementary 2

The system according to supplementary 1,
wherein the processor is configured to control the terminal to serialize the structured information into a lightweight data format having a hierarchical structure and to transmit the lightweight data format to a server, and to execute processing at the server to deserialize the lightweight data format and extract the experiential information.

### Supplementary 3

The system according to supplementary 1,
wherein the processor is configured to convert the experiential information into category-specific text fragments, generate the prompt sentence based on a prompt template including the text fragments and output constraint conditions, and explicitly specify in the prompt sentence constraints relating to length, number of sentences, style, and publication format of an output sentence so as to cause the generative AI model to generate a short comment in accordance with the constraints.

### Application Example 2

### Supplementary 1

A system comprising a processor,
wherein the processor is configured to
generate visual symbols on the basis of environmental information acquired from an environmental information storage unit, and construct character information representing the environmental information, and
execute environmental information acquisition processing on the basis of position information acquired from a terminal device, and generate display information for presenting, together with the environmental information, selection items for subjective information input to the terminal device, and
estimate emotion information corresponding to subjective information on the basis of selection items representing the subjective information acquired from the terminal device and user information, and
generate a prompt sentence for instructing a generative AI model to generate character information, on the basis of the environmental information, the subjective information, and the emotion information, and
input the prompt sentence to the generative AI model and acquire generated character information from the generative AI model, and
execute information processing including summarization processing on the generated character information to generate simplified character information, and
store the simplified character information in association with the environmental information and the user information in a storage unit, and
generate display information including the simplified character information and transmit the display information to the terminal device, and
convert the simplified character information into a publication format and transmit the simplified character information in the publication format to an information distribution infrastructure via a communication network.

### Supplementary 2

The system according to supplementary 1,
wherein the processor is configured to
execute emotion analysis processing using an emotion analysis function on the basis of the subjective information and the user information, calculate an emotion type and an intensity as the emotion information, and include the emotion type and the intensity in the prompt sentence.

### Supplementary 3

The system according to supplementary 1,
wherein the processor is configured to
select template information from among a plurality of templates associated with the environmental information, the subjective information, and the emotion information, and dynamically construct the prompt sentence by inserting the environmental information, the subjective information, and the emotion information into the selected template information.

What is claimed is:

1. A system comprising:
circuitry configured to:
acquire, via a communication interface coupled to a packet-switched network, environmental condition data from an information storage device, and generate graphical indicator data and descriptive text data corresponding to the environmental condition data;
receive, from a terminal device via the communication interface, selection parameter data representing user-perceived attributes of an environment selected from a plurality of selectable attribute categories;
construct an instruction sequence comprising the environmental condition data, the selection parameter data, and a generation constraint parameter specifying an output length and an expression style, and input the instruction sequence into a generative neural network model comprising a transformer-based architecture to generate output text data;
execute a text reduction operation on the output text data to produce simplified text data in accordance with the generation constraint parameter; and
generate response data associating the graphical indicator data, the simplified text data, and the selection parameter data, and transmit the response data to the terminal device via the communication interface.

2. The system according to claim 1, wherein the circuitry is further configured to:
receive position data from the terminal device, transmit the position data to an external data acquisition interface to obtain the environmental condition data corresponding to a geographic location indicated by the position data, and store the environmental condition data in the information storage device.

3. The system according to claim 2, wherein the circuitry is further configured to:
normalize the environmental condition data by classifying numerical measurement values into discrete category labels using threshold-based classification, and map the discrete category labels to graphical indicator identifiers stored in a mapping table.

4. The system according to claim 1, wherein the selection parameter data comprises:
a first attribute value representing a perceived brightness level selected from a plurality of brightness options, and a second attribute value representing a perceived humidity level selected from a plurality of humidity options, the first attribute value and the second attribute value each represented as a categorical code.

5. The system according to claim 4, wherein the circuitry is further configured to:
map each categorical code in the selection parameter data to a descriptive text fragment using a stored mapping table, and concatenate the descriptive text fragments with the environmental condition data to construct a generation input text portion of the instruction sequence.

6. The system according to claim 1, wherein the generation constraint parameter further comprises:
a target language identifier, a maximum output token count, a sentence count limit, and a publication context indicator, and the circuitry is further configured to embed the generation constraint parameter as natural language instructions within the instruction sequence to condition the generative neural network model to produce output text data conforming to the constraints.

7. The system according to claim 1, wherein the generative neural network model comprises:
an embedding layer configured to convert tokens of the instruction sequence into embedding vectors, a positional encoding module, a plurality of transformer layers each comprising multi-head self-attention and feed-forward sublayers with layer normalization, and a decoding stage configured to generate a probability distribution over a vocabulary and select output tokens using a sampling strategy controlled by a temperature parameter and a sampling threshold.

8. The system according to claim 1, wherein the text reduction operation comprises:
segmenting the output text data into sentence units, computing a relevance score for each sentence unit based on term frequency and positional weighting, selecting sentence units having relevance scores exceeding a threshold, and concatenating the selected sentence units to produce the simplified text data.

9. The system according to claim 8, wherein the text reduction operation alternatively comprises:
inputting the output text data into a secondary neural network model configured for text compression, the secondary neural network model generating the simplified text data as a condensed representation of the output text data within a maximum character count.

10. The system according to claim 1, wherein the circuitry is further configured to:
parse the output text data to extract category identifier data from a list segment within the output text data, map the category identifier data to item records stored in a product data storage device using keyword matching, and include the item records in the response data transmitted to the terminal device.

11. The system according to claim 10, wherein the circuitry is further configured to:
construct the instruction sequence to include a format specification instructing the generative neural network model to produce the output text data as a descriptive segment followed by a delimited list segment, the delimited list segment comprising category identifiers separated by predetermined delimiters.

12. The system according to claim 1, wherein the circuitry is further configured to:
extract affective state features from the selection parameter data and user profile data, input the affective state features into an emotion classification neural network configured to output probability values over a plurality of affective state categories, determine an affective state type and an intensity value, and include the affective state type and the intensity value in the instruction sequence to condition the generative neural network model to adapt the output text data based on the determined affective state.

13. The system according to claim 12, wherein the circuitry is further configured to:
select a prompt template from a plurality of stored prompt templates based on a combination of the environmental condition data, the selection parameter data, and the affective state type, and construct the instruction sequence by inserting specific values into placeholders of the selected prompt template.

14. The system according to claim 1, wherein the circuitry is further configured to:
store the simplified text data in association with the environmental condition data, the selection parameter data, and a user identifier in an information storage device as a content record, and retrieve stored content records to generate feed data comprising a plurality of content records formatted for sequential display on the terminal device.

15. The system according to claim 14, wherein the circuitry is further configured to:
convert the simplified text data into a publication format data structure and transmit the publication format data structure to an external distribution platform via the communication interface, the external distribution platform making the simplified text data accessible to other users.

16. The system according to claim 1, wherein the circuitry is further configured to:
adjust the generation constraint parameter based on a device capability indicator received from the terminal device, such that a terminal device with limited display capacity receives a shorter maximum output token count and a more restrictive sentence count limit.

17. The system according to claim 16, wherein the environmental condition data comprises weather condition data including temperature, humidity, and precipitation parameters, the selection parameter data represents subjective perceptions of sky brightness and humidity feeling, and the simplified text data comprises a natural language description of weather conditions adapted for display on a social media platform or an information service interface.

18. A system comprising:
circuitry configured to:
acquire environmental condition data from an information storage device and generate graphical indicator data corresponding to the environmental condition data;
receive selection parameter data from a terminal device via a communication interface, the selection parameter data representing user-perceived environmental attributes selected from a plurality of selectable categories;
map the selection parameter data to descriptive text fragments, construct an instruction sequence comprising the environmental condition data, the descriptive text fragments, and generation constraint parameters, and input the instruction sequence into a generative neural network model to generate output text data;
execute a text reduction operation on the output text data to produce simplified text data; and
associate the graphical indicator data and the simplified text data in response data and transmit the response data to the terminal device.

19. The system according to claim 18, wherein the circuitry is further configured to:
extract affective state features from the selection parameter data and user profile data, determine an affective state type using an emotion classification neural network, select a prompt template based on the affective state type and the environmental condition data, and include the affective state type in the instruction sequence.

20. A method comprising:
acquiring, by circuitry via a communication interface coupled to a packet-switched network, environmental condition data from an information storage device, and generating graphical indicator data and descriptive text data corresponding to the environmental condition data;
receiving, from a terminal device via the communication interface, selection parameter data representing user-perceived attributes of an environment selected from a plurality of selectable attribute categories;
constructing an instruction sequence comprising the environmental condition data, the selection parameter data, and a generation constraint parameter specifying an output length and an expression style, and inputting the instruction sequence into a generative neural network model comprising a transformer-based architecture to generate output text data;
executing a text reduction operation on the output text data to produce simplified text data in accordance with the generation constraint parameter; and
generating response data associating the graphical indicator data, the simplified text data, and the selection parameter data, and transmitting the response data to the terminal device via the communication interface.
